(19) United States
(12) Patent Application Publication
(10) Pub. No.: US 2025/0245696 A1
(43) Pub. Date: Jul. 31, 2025

(54) ARTIFICIAL INTELLIGENCE TECHNIQUES FOR LARGE SCALE RANKING

(71) Applicant: Microsoft Technology Licensing, LLC, Redmond, WA (US)

(72) Inventors: Fedor Borisyuk, Mountain View, CA (US); Qingquan Song, Sunnyvale, CA (US); Hailing Cheng, San Jose, CA (US); Mingzhou Zhou, Santa Clara, CA (US)

(73) Assignee: Microsoft Technology Licensing, LLC, Redmond, WA (US)

(21) Appl. No.: 18/640,768

(22) Filed: Apr. 19, 2024

Related U.S. Application Data
(60) Provisional application No. 63/626,947, filed on Jan. 30, 2024.

(51) Int. Cl. G06Q 30/0251

(52) U.S. Cl. CPC G06Q 30/0251

(57) ABSTRACT

Embodiments are generally directed to artificial intelligence (AI) and machine learning (ML) techniques for networking platforms, such as a social networking system or a connections networking system. Some embodiments are particularly directed to an AI system implementing ML techniques to support automated networking platform services for members of a networking platform, such as serving content, providing job recommendations, performing feed ranking, serving targeted advertising, predicting advertising click-through-rates (CTR), and other types of networking platform services to engage and provide value to members. In one embodiment, for example, the AI system utilizes an industrial large scale ranking model. Other embodiments are described and claimed.

This application claims the benefit of and priority to previously filed U.S. Provisional Patent Application Ser. No. 63/626,947, filed Jan. 30, 2024, entitled “ARTIFICIAL INTELLIGENCE TECHNIQUES FOR LARGE SCALE RANKING”, which is hereby incorporated by reference in its entirety.

### BACKGROUND

A social networking system is an online platform where users can create profiles, connect with friends, family, and colleagues, and share various types of content such as photos, videos, and status updates. These platforms often offer features like messaging, groups, events, and news feed to keep users engaged and connected. Social networking systems facilitate communication, networking, and content sharing among users, creating a digital community where people can interact and engage with others in their social circle or with like-minded individuals. Similarly, a connections networking system allows individuals to connect with colleagues, potential employers, and other connections in their industry. It is geared towards connections networking, job searching, and recruiting. Users can create a profile showcasing their work experience, skills, and education, as well as connect with others in their field. Connections networking systems also provide a platform for sharing content, participating in discussions, and accessing industry news and insights.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a model architecture for a residual deep and cross network (DCN) in accordance with one embodiment.

FIG. 2A illustrates stacked structure in accordance with one embodiment.

FIG. 2B illustrates a parallel structure in accordance with one embodiment.

FIG. 3 illustrates a cross layer in accordance with one embodiment.

FIG. 4 illustrates a model architecture in accordance with one embodiment.

FIG. 5 illustrates a calibration model in accordance with one embodiment.

FIG. 6 illustrates an isotonic layer representation in accordance with one embodiment.

FIG. 7 illustrates a networking system in accordance with one embodiment.

FIG. 8 illustrates a content delivery system in accordance with one embodiment.

FIG. 9 illustrates a logic flow in accordance with one embodiment.

FIG. 10 illustrates a logic flow in accordance with one embodiment.

FIG. 11 illustrates a large ranking model in accordance with one embodiment.

FIG. 12 illustrates a large ranking model in accordance with one embodiment.

FIG. 13 illustrates root object wide model in accordance with one embodiment.

FIG. 14 illustrates a vocabulary hashing model in accordance with one embodiment.

FIG. 15 illustrates system in accordance with one embodiment.

FIG. 16 illustrates a model architecture in accordance with one embodiment.

FIG. 17 illustrates a model architecture in accordance with one embodiment.

FIG. 18 illustrates a system in accordance with one embodiment.

FIG. 19 illustrates an apparatus in accordance with one embodiment.

FIG. 20 illustrates an artificial intelligence architecture in accordance with one embodiment.

FIG. 21 illustrates an artificial neural network in accordance with one embodiment.

FIG. 22 illustrates a computer-readable storage medium in accordance with one embodiment.

FIG. 23 illustrates a computing architecture in accordance with one embodiment.

FIG. 24 illustrates a communications architecture in accordance with one embodiment.

### DETAILED DESCRIPTION

Embodiments are generally directed to artificial intelligence (AI) and machine learning (ML) techniques for networking platforms, such as a social networking system or a connections networking system. Some embodiments are particularly directed to an AI system implementing novel ML techniques to support automated networking platform services for members of a networking platform, such as serving content, providing job recommendations, performing feed ranking, serving targeted advertising, predicting advertising click-through-rates (CTR), and other types of networking platform services to engage and provide value to members. In one embodiment, for example, the AI system utilizes an industrial large scale ranking model. Although exemplary embodiments are described in connection with a particular AI system or an ML model, the principles described herein can also be applied to other types of AI systems and ML models as well. Embodiments are not limited in this context.

Networking platforms, such as social networking systems and connections networking systems, often use AI and ML for various downstream tasks, such as providing recommendations, targeted advertising, and serving content. AI systems and ML models typically implement some form of ranking system to support such services. For example, learning to rank (LTR) remains an important problem in modern-day machine learning and deep learning. It has a wide range of applications in search, recommendation systems, and computational advertising.

Despite improvements in LTR models, networking platforms still find it difficult to generate precise recommendations for their members. A connections networking system often stores a wealth of information about its members, such as their industry, current jobs, previous job history, web site interactions, varying levels of connections to other members, demographics, education, interests, accomplishments, organization affiliations, conferences, and so forth. A ML model can potentially use this information as features for a prediction task, such as recommending advertisements or job openings. However, it remains difficult for an ML model to learn which features, or combination of features, actually improve accuracy for a given prediction task. A ML model cannot generate a precise recommendation if the ML model does not recognize which features or feature combinations are more important relative to others.

To solve these and other challenges, embodiments are generally directed to an improved AI system using a model architecture suitable to support downstream prediction tasks for networking platforms, such as those used by connections networking systems and/or social networking systems. Examples of downstream prediction tasks may include predictions, suggestions or inferences for network services offered by networking platforms, such as ranking services, recommendation services, content delivery services, and other types of networking operations. The AI system makes deployment of networking services more practical in large-scale industrial settings. Further, the AI system provides more accurate and precise predictions for downstream prediction tasks to support networking services, thereby allowing networking platforms to provide improved networking services and more value to their members.

In one embodiment, for example, a connections networking system may implement an AI system that uses a residual deep and cross network (DCN) to improve a quality and accuracy of predictions. Specifically, the residual DCN comprises a cross network and a deep network. The cross network comprises a set of cross layers to analyze feature crosses for a set of input features. The residual DCN implements a set of attention data structures for one or more cross layers of the cross network to help focus on more important feature crosses for a given prediction task. An ML model may generate a prediction vector based on the final output from the residual DCN. Further, the prediction vector may need calibration with ground truth values to increase accuracy of the predicted values. Therefore, the ML model (or another model) may implement a novel isotonic calibration layer trained with the ML model to calibrate predicted values (e.g., predicted scores) with measured values (e.g., actual scores). Other embodiments are described and claimed.

An AI system using these and other model advancements overcome various technical challenges of conventional systems, such as diminishing returns, overfitting, divergence, different gains across applications, and other technical challenges. Further, the AI system may quickly determine which set of features or feature crosses improve accuracy for a given prediction task. As previously discussed, connections networking system may store a wealth of information about its members, such as their industry, current jobs, previous job history, web site interactions, varying levels of connections to other members, demographics, education, interests, accomplishments, organization affiliations, conferences, and so forth. An ML model can potentially use this information as features for a prediction task, such as predicting custom content for a feed, advertisements, job recommendations, article recommendations, connections, and other networking services. The AI system may effectively and efficiently learn which of these features, or combination of features, actually improve accuracy for a given prediction task. Further, the AI system can operate at web-scale for large cloud-based production systems used by connections networking systems. In addition, the AI system may support ranking systems for serving content, providing job recommendations, performing feed ranking, serving targeted advertising, predicting advertising CTR, and other types of networking platform services to engage and provide value to members. The model advancements also result in a model that efficiently handles a larger number of parameters, thereby leading to higher-quality content delivery for recommendation systems. For example, the AI system provides measured improvements of +0.5% member sessions in Feed Services, +1.76% job applications in Job Recommendations Services, and +4.3% improvement to advertising CTR. Other technical advantages exist as well.

Any of the above embodiments may be implemented as instructions stored on a non-transitory computer-readable storage medium and/or embodied as an apparatus with a memory and a processor configured to perform the actions described above. It is contemplated that these embodiments may be deployed individually to achieve improvements in resource requirements and library construction time. Alternatively, any of the embodiments may be used in combination with each other in order to achieve synergistic effects, some of which are noted above and elsewhere herein.

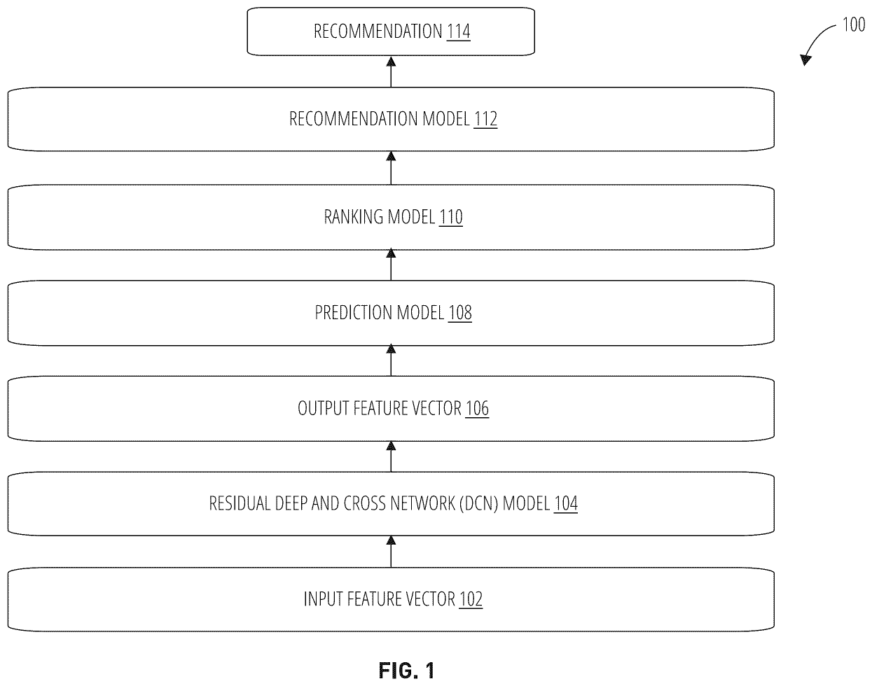

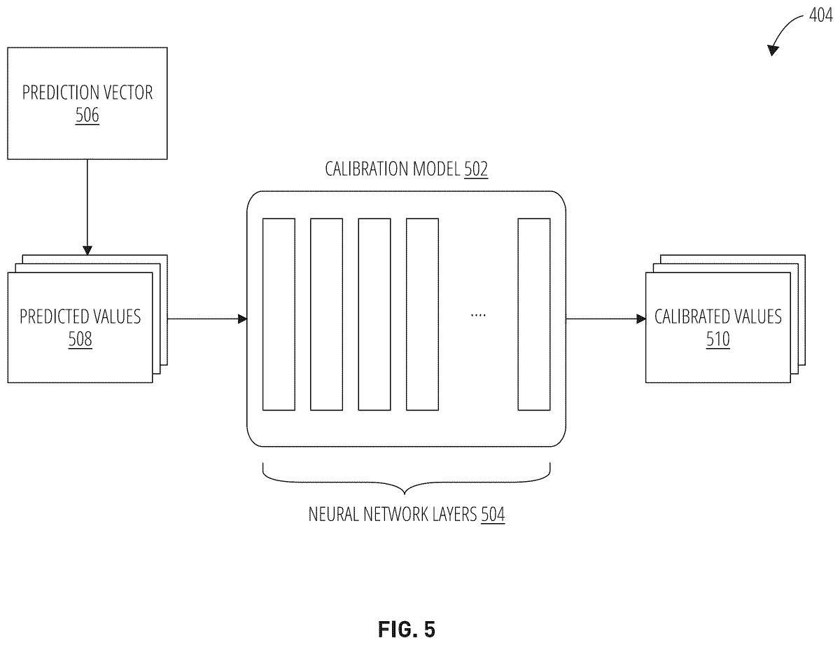

FIG. 1 illustrates a model architecture 100. The model architecture 100 is an example of a model architecture suitable for implementation by an AI system for a connections networking system. The model architecture 100 comprises multiple components, such as an input feature vector 102, a residual DCN model 104, an output feature vector 106, a prediction model 108, a ranking model 110, a recommendation model 112, and a recommendation 114. It may be appreciated that the model architecture 100 may comprise more or less components as needed for a given implementation. For example, the model architecture 100 may include a calibration model using an isotonic calibration layer to calibrate predicted values with measured values, as described with reference to FIG. 5. Embodiments are not limited in this context.

The model architecture 100 may generate or receive an input feature vector 102 for a residual DCN model 104. An input feature vector 102 is a set of numeric or categorical features that are used as inputs to the network. The input feature vector 102 may include various attributes or characteristics of the data, such as user behavior, item attributes, or other relevant factors depending on the specific application. As previously discussed, connections networking system may store a wealth of information about its members, such as their industry, current jobs, previous job history, web site interactions, varying levels of connections to other members, demographics, education, interests, accomplishments, organization affiliations, conferences, and so forth. An ML model, such as the residual DCN model 104, can potentially use this information as features for a prediction task, such as predicting custom content for a feed, advertisements, job recommendations, article recommendations, connections, and other networking services. These features are then processed by the residual DCN model 104 to learn complex patterns and interactions that may not be adequately captured by traditional deep learning or linear models.

When working with residual DCN model 104, it is important to carefully select and preprocess the input features to ensure that they effectively capture the information needed for the network to learn and make accurate predictions. Examples of a set of features for the input feature vector 102 includes without limitation one or more numerical features, categorical features, categorical feature embeddings from a lookup table, dense embeddings, sparse identifier embeddings, or member history features defined for the connections networking system. Embodiments are not limited to these examples.

The model architecture 100 may comprise or implement a residual DCN model 104 to improve a quality and accuracy of predictions. The residual DCN model 104 is designed to capture both low-level interactions modeled by a deep part of the network and high-level interactions modeled by a cross part of the network between features of the input feature vector 102. Further, the residual DCN model 104 incorporates attention data structures to cross layers of a cross network of the residual DCN model 104 to focus on important feature crosses. For each cross layer of a cross network, the residual DCN model 104 replaces a full rank matrix (e.g., a weight matrix) with a pair of low-rank matrices that are low-rank approximations of the full rank matrix. This accelerates operations of the residual DCN model 104. One of the low-rank matrices is duplicated into three attention data structures, including a value matrix, a query matrix, and a key matrix. The query matrix and the key matrix are multiplied to form an attention score matrix. A cross layer uses the attention score matrix to calculate an output vector. The attention data structures focus the cross network on the most important feature crosses of features from the input feature vector 102. In addition, the cross layer adds a residual connection to the output vector via a skip connection. This allows the residual DCN model 104 to learn effective explicit and implicit feature crosses while reducing parameter counts and training times.

More particularly, the residual DCN model 104 is a neural network architecture designed for feature learning in tabular data used in fields such as LTR, recommendation systems and CTR prediction. Components of the residual DCN model 104 include a deep component and a cross component. Similar to a deep neural network (DNN), the deep component of the residual DCN model 104 comprises multiple layers of perceptrons. The deep component is responsible for capturing complex, non-linear relationships in the data. The cross component explicitly applies feature crossing at each layer. Feature crosses provide interaction information beyond individual features. For example, a combination of features such as “country” and “language” is more informative than either feature alone. The cross component takes raw features and their cross-products as input, allowing the network to learn certain feature interactions more effectively. The residual DCN model 104 combines outputs of both the deep component and the cross component in order to make a prediction. This combination allows the model to learn both deep (e.g., complex and abstract) and cross (e.g., specific and direct) feature interactions simultaneously. The residual DCN model 104 is particularly effective for tabular data where interactions between different features can be crucial for making accurate predictions. It offers an efficient way to automatically learn feature interactions, which might be difficult or impossible to specify manually. This makes residual DCN model 104 very useful in scenarios like online advertising, where predicting user behavior based on a large set of features is important.

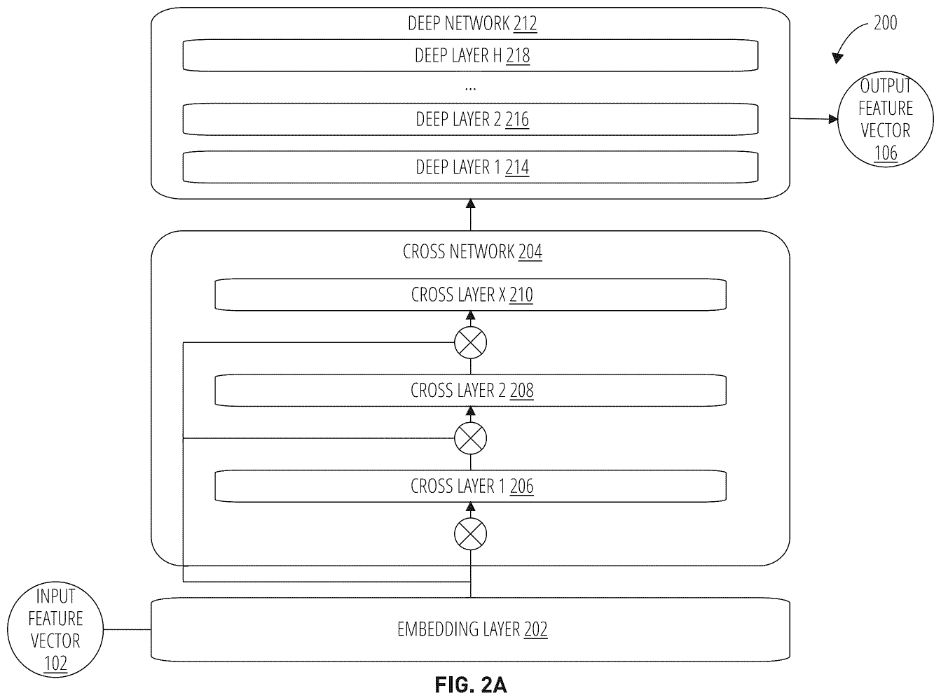

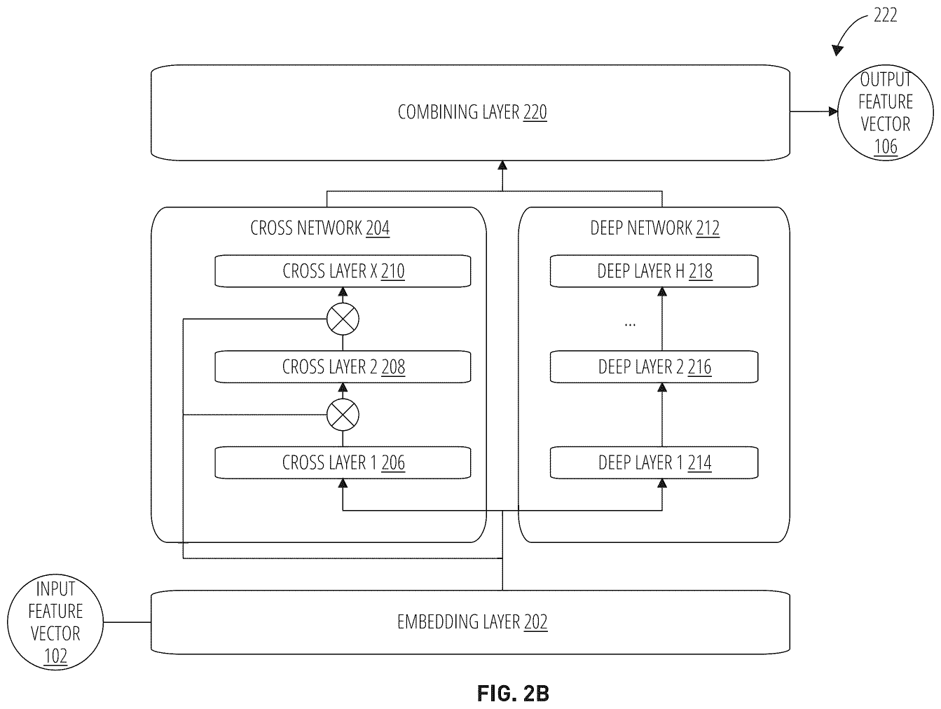

In one embodiment, for example, the residual DCN model 104 simplifies a structure of the cross component while still capturing complex feature interactions. For example, a cross network may use a full-rank weight matrix, which can consume significant compute, memory, and bandwidth resources for a networking system. Embodiments replace the full-rank weight matrix with a set of low-rank matrices using low-rank approximation techniques. In this manner, the residual DCN model 104 reduces a number of parameters required for each cross layer. The residual DCN model 104 streamlines the modeling of feature interactions, reducing computational overhead without compromising the depth and quality of the interactions captured. This reduction in complexity makes the model leaner and more efficient, facilitating quicker training cycles and reducing the computational resources needed for both training and inference. The streamlined operation simplifies the forward pass and backpropagation, leading to faster computation and more efficient learning. An example for the residual DCN model 104 is described in more detail with reference to FIG. 2A and FIG. 2B.

The model architecture 100 may generate an output feature vector 106 from the input feature vector 102. The output feature vector 106 refers to a vector of features that is produced by the residual DCN model 104 in response to the input feature vector 102. After processing the input features of the input feature vector 102 through the deep and cross components of the residual DCN model 104, the output feature vector 106 represents a learned representation of the input and is used for making predictions or further processing. The output feature vector 106 may encapsulate an understanding of the input data by the residual DCN model 104, potentially capturing complex patterns and interactions between the input features that are relevant to the specific task for which the model architecture 100 is designed. The exact composition of the output feature vector 106 will depend on the architecture and parameters of the residual DCN model 104, as well as the nature of the input data and the learning objective. The output feature vector 106 is often used as the input to subsequent layers or modules in the overall AI system, or as the final representation for making predictions, classifications, or recommendations depending on the specific application of the residual DCN model 104.

The model architecture 100 may comprise or implement a prediction model 108. The prediction model 108 is the layer of the model architecture 100 that is responsible for producing the output predictions or decisions based on the learned representations of the input data. It makes predictions based on the input features. In the context of deep learning, the prediction model 108 is often a fully connected layer or a SoftMax layer, depending on the nature of the task. For classification tasks, the prediction model 108 typically consists of a SoftMax activation function that generates probability scores for each class, allowing the model architecture 100 to produce a probability distribution over the possible output classes. In regression tasks, the prediction model 108 may comprise a single neuron (node) that outputs a continuous numerical value. The prediction model 108 operates on the learned features extracted by the preceding layers of the model architecture 100 and maps these features to the desired output format (e.g., class probabilities in classification tasks). The output of the prediction model 108 can then be used to make decisions, classify data, or generate predictions based on new input samples. Additionally, in some network architectures, such as recurrent neural networks (RNNs) and transformers, the prediction model 108 may also include temporal or sequential processing to make predictions based on input sequences or time-series data. It is worthy to note that although the prediction model 108 is shown as a separate model, it may be appreciated that the prediction model 108 may be combined with another ML model, such as the residual DCN model 104, for example. This decision may be driven by design considerations such as available system resources, training time, and application requirements.

The model architecture 100 may comprise or implement a ranking model 110. The ranking model 110 assigns a score or rank to a set of items or entities based on their relevance to a particular query or context. This concept is useful for information retrieval, recommendation systems, search engines, and other applications where the goal is to prioritize or order a list of items according to their perceived importance or suitability. In the context of a ranking model 110, a ML model is trained to learn the underlying patterns and preferences in the data in order to assign appropriate ranks to items. For example, in a search engine, the ranking system might prioritize web pages based on their relevance to a user's query, while in a recommendation system, the ranking system could order products or content based on their predicted appeal to a user. ML models used in ranking models 110 often leverage algorithms such as learning-to-rank (LTR) methods, which aim to directly optimize a ranking function based on pairs or lists of items and their associated relevance or preference scores. This allows the ML model to learn to order items in a way that aligns with human judgments or user behavior. Overall, a ranking model 110 enhances the user experience by presenting the most relevant or preferred items at the top of the list, ultimately increasing the likelihood of satisfying the user's needs or preferences.

The model architecture 100 may comprise or implement a recommendation model 112 designed to output a recommendation 114. The recommendation model 112 is a type of algorithm or system designed to predict or suggest items of interest to users based on their preferences or behavior. These systems are useful in various applications, such as connections networking systems, social networking systems, e-commerce platforms, streaming services, content curation, and personalized marketing, with the goal of providing users with relevant and engaging recommendations. The recommendation model 112 typically leverages ML techniques to analyze user data, item characteristics, and historical interactions in order to make personalized recommendations. Recommendation model 112 may encompass several types, including collaborative filtering, content-based filtering, hybrid methods, and matrix factorization and embedding models. These systems are designed to predict or suggest items to users based on their preferences and interactions. For example, collaborative filtering analyzes user-item interactions to identify similarities between users or items, while content-based filtering recommends items based on their attributes. Hybrid methods combine both approaches, and matrix factorization and embedding models represent users and items as vectors in a latent space. Regardless of the specific type, recommendation model 112 leverages machine learning techniques to provide personalized, relevant recommendations, thereby enhancing user experience and engagement in various domains such as connections networking systems, e-commerce, content curation, and personalized marketing. Recommendation model 112 enhances user experience, increasing user engagement, and driving business outcomes by effectively matching users with relevant content, products, or services. ML models used in recommendation models 112 are trained to understand and model user preferences, item characteristics, and contextual information to provide personalized and valuable recommendations to users.

In general operation, the model architecture 100 may generate an input feature vector 102 for a set of features relevant to a connections networking system for input to a residual DCN model 104. The residual DCN model 104 receives the input feature vector 102, and it generates an output feature vector 106 representing explicit feature crosses and/or implicit feature crosses of the input feature vector 102. For explicit feature crosses, the residual DCN model 104 may use a set of cross layers of a cross network of the residual DCN model 104, with at least one cross layer comprising a set of attention data structures to generate attention scores for feature crosses of the set of features from the input feature vector 102, where higher attention scores represent higher predictive feature crosses for a defined prediction task. For implicit feature crosses, the residual DCN model 104 may use a deep network such as a DNN.

The residual DCN model 104 combines output vectors from the cross network and the deep network as a unified output feature vector 106, which is then used as input to the prediction model 108. The prediction model 108 receives the output feature vector 106, and it generates a prediction vector for the defined prediction task based, at least in part, on the output feature vector 106. The prediction model 108 outputs the prediction vector to the ranking model 110 to perform ranking operations. The ranking model 110 receives the prediction vector as input, and it outputs a ranked list based on the prediction vector to the recommendation model 112. The recommendation model 112 receives the ranked list, and it generates a recommendation 114 for a networking service of the connections networking system.

As previously described, the residual DCN model 104 attempts to leverage both explicit feature crosses using a cross network 204 and implicit feature crosses from a deep network 212 (e.g., a DNN). To model explicit feature crosses, the cross network 204 and the deep network 212 implements a function ƒ(x1, x2) to efficiently and explicitly model the pairwise interactions between features x1 and x2.

There are different ways to combine the cross network 204 and the deep network 212. FIG. 2A illustrates the stacked structure 200 as one way to combine the cross network 204 and the deep network 212. FIG. 2B illustrates a parallel structure 222 as another way to combine the cross network 204 and the deep network 212. Embodiments may use either the stacked structure 200 or the parallel structure 222 for the residual DCN model 104 depending on a given application. Embodiments are not limited to a particular configuration.

FIG. 2A provides an example of a stacked structure 200 for the residual DCN model 104. The stacked structure 200 combines a cross network 204 and a deep network 212 by stacking the deep network 212 on the cross network 204.

As depicted in FIG. 2A, the stacked structure 200 comprises an embedding layer 202, and a cross network 204 and a deep network 212 stacked in sequential order. The embedding layer 202 receives the input feature vector 102. The embedding layer 202 takes input as a combination of categorical (sparse) and dense features from the input feature vector 102, and it outputs an embedded vector to the cross network 204. The embedded vector may comprise varying embedding sizes depending on the application.

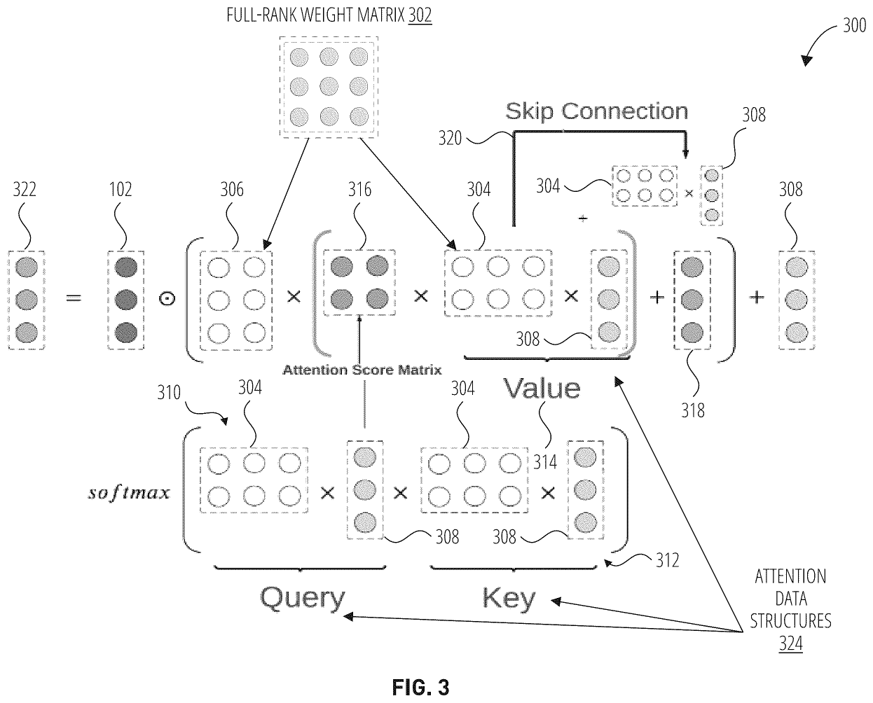

The cross network 204 receives the embedded vector from the embedding layer 202 and it processes the embedded vector through one or more cross layers 1-X, such as cross layer 1 206, cross layer 2 208, and cross layer X 210, where X is any positive integer. Each cross layer processes the embedded vector, and generates an output that is fed into the next cross layer. This process is described in more detail with reference to FIG. 3. The output of the cross network 204 is a concatenation of all the embedded vectors, which is passed to the deep network 212.

The deep network 212 receives the output of the cross network 204 and it processes the output through one or more deep layers 1-H, such as deep layer 1 214, deep layer 2 216, and deep layer H 218, where H is any positive integer. The final layer models the data as X_{final}=f_{deep}○f_{cross} and outputs the output feature vector 106.

FIG. 2B provides an example of a parallel structure 222 for the residual DCN model 104. The parallel structure 222 combines a cross network 204 and a deep network 212 by jointly training two parallel networks.

As depicted in FIG. 2B, the stacked structure 200 comprises an embedding layer 202, and a cross network 204 and a deep network 212 in parallel order. The embedding layer 202 receives the input feature vector 102. The embedding layer 202 takes input as a combination of categorical (sparse) and dense features from the input feature vector 102, and it outputs an embedded vector to the cross network 204 and the deep network 212. The embedded vector may comprise varying embedding sizes depending on the application.

The cross network 204 receives the embedded vector from the embedding layer 202 and it processes the embedded vector through one or more cross layers 1-X, such as cross layer 1 206, cross layer 2 208, and cross layer X 210, where X is any positive integer. Each cross layer processes the embedded vector, and generates an output that is fed into the next cross layer. This process is described in more detail with reference to FIG. 3. The output of the cross network 204 is a concatenation of all the embedded vectors, which is passed to a combining layer 220.

In parallel, the deep network 212 receives the embedded vector from the embedding layer 202, and it processes the embedded vector through one or more deep layers 1-H, such as deep layer 1 214, deep layer 2 216, and deep layer H 218, where H is any positive integer. The output of the deep network 212 is passed to the combining layer 220.

The combining layer 220 operates as a final layer that models the data as X_{final}=f_{deep}+f_{cross} and it outputs the output feature vector 106.

FIG. 3 illustrates a structure of an attention cross layer 300. The attention cross layer 300 may comprise an example of a cross layer 1-X of the cross network 204 for the residual DCN model 104.

The attention cross layer 300 may comprise an example of a cross layer that includes a scaled dot-product self-attention component. In one embodiment, for example, a temperature could also be added to balance the complicacy of the learned feature interactions. In one embodiment, for example, the attention cross layer 300 may be degenerated to a normal cross network when an attention score matrix 316 is an identity matrix. In some cases, adding a residual connection 320 and fine-tuning the attention temperature is beneficial for helping learn more complicated feature correlations while maintaining stable training. By paralleling a low-rank cross network with an attention low-rank cross network, the residual DCN model 104 provides a statistically significant improvement on a downstream task, such as a feed ranking task for example.

As previously described, for explicit feature crosses, the residual DCN model 104 may use a set of cross layers of a cross network 204 of the residual DCN model 104. At least one of the cross layers may be implemented as an attention cross layer 300. The attention cross layer 300 may comprise a set of attention data structures to generate attention scores for feature crosses of the set of features from the input feature vector 102, where higher attention scores represent higher predictive feature crosses for a defined prediction task.

As depicted in FIG. 3, the attention cross layer 300 creates explicit feature crosses from the input feature vector 102. Equation (1) shows the (1+1)th cross layer:

$${x}_{l + 1} = {x}_{0} ⊙ ( {W}_{l} {x}_{l} + {b}_{l} ) + {x}_{l} \qquad Equation ( 1 )$$

Where X₀ is the original features of order 1, Xₗ represents the input to the cross layer, Xₗ₊₁ represents the output of the cross layer, Wₗ is a weight matrix, and bi is a bias vector. The weight matrix Wₗ is a full-rank weight matrix 302.

To automatically capture feature interactions, embodiments utilize one or more cross layers 1-X, such as attention cross layer 300, for the cross network 204 of the residual DCN model 104. Offline experiments revealed that two cross layers (X=2) may provide sufficient interaction complexity. In some cases, adding more layers may yield diminishing relevance gains while increasing training and serving times significantly. Despite using just two layers, the use of the weight matrix Wₗ adds a considerable number of parameters due to the large feature input dimension. To address this, the residual DCN model 104 adopts two strategies for enhancing efficiency. First, the residual DCN model 104 replaces the weight matrix Wₗ with two skinny matrices resembling a low-rank approximation. Second, the residual DCN model 104 reduces an input feature dimension by replacing sparse one-hot features with embedding-table look-ups, resulting in nearly a 30% reduction. These modifications allows the residual DCN model 104 to substantially reduce parameter counts with only minor effects on relevance gains, making it feasible to deploy the model on modern central processing units (CPUs).

With respect to the first solution, embodiments replace the full-rank weight matrix 302 with a set of low-rank matrices representing low-rank approximations of the full-rank weight matrix 302. The set of low-rank matrices comprise a first low-rank matrix 304 representing a first subspace of the full-rank weight matrix 302 and a second low-rank matrix 306 representing a second subspace of the full-rank weight matrix 302.

The first low-rank matrix 304 and the second low-rank matrix 306 are used to form a set of attention data structures 324 using a cross layer input feature vector 308 from the input feature vector 102. The set of attention data structures 324 comprise an attention score matrix 316 and a value matrix 314. The attention score matrix 316 comprises a combination of a query matrix 310 and a key matrix 312.

To further enhance the power of the residual DCN model 104, specifically, the cross network 204, the residual DCN model 104 introduces an attention schema in the low-rank cross network. Specifically, the original low-rank mapping is duplicated as three with different mapping kernels, where the original one serves as a value matrix 314 and the other two as a query matrix 310 and a key matrix 312, respectively. An attention score matrix 316 is computed and inserted between the low-rank mappings.

The cross layer input feature vector 308 is generated based on the input feature vector 102. The attention cross layer 300 receives the cross layer input feature vector 308, and it multiplies the cross layer input feature vector 308 with first low-rank matrix 304 of the set of low-rank matrices to form a query matrix 310. The attention cross layer 300 multiplies the cross layer input feature vector 308 with the first low-rank matrix 304 of the set of low-rank matrices to form a key matrix 312. The attention cross layer 300 multiplies the query matrix 310 and the key matrix 312 to form the attention score matrix 316.

The attention cross layer 300 generates a cross layer output feature vector 322 using a set of operations visualized in FIG. 3. The attention cross layer 300 multiplies a first cross layer input feature vector 308 with the first low-rank matrix 304 of a set of low-rank matrices and an attention score matrix 316 to form a first intermediate result. The attention cross layer 300 multiplies the first intermediate result with the second low-rank matrix 306 of the set of low-rank matrices to form a second intermediate result. The attention cross layer 300 adds a bias vector 318 to the second intermediate result to form a third intermediate result. The attention cross layer 300 multiplies the third intermediate result with the input feature vector 102 to form a fourth intermediate result. The attention cross layer 300 adds the first cross layer input feature vector 308 to the fourth intermediate result via a residual connection to form the cross layer output feature vector 322, where the residual connection comprises a skip residual connection 320. The cross layer output feature vector 322 is fed into the next cross layer as a new cross layer input feature vector 308.

This process repeats for all the cross layers 1-X of the cross network 204. In one embodiment, two cross layers (X=2) are implemented for the cross network 204. For example, a first cross layer output feature vector 322 is generated by a first cross layer 1 206 based on the input feature vector 102 and a first cross layer input feature vector 308. A second cross layer output feature vector 322 is generated by a second cross layer 2 208 based on the input feature vector 102 and the first cross layer output feature vector 322. The second cross layer output feature vector 322 is fed to an output layer of the cross network 204.

In a sequential fashion using the stacked structure 200 or a parallel fashion using the parallel structure 222, the deep network 212 generates a second output feature vector representing implicit feature crosses of the input feature vector 102 using a DNN of the residual DCN model 104. The first output feature vector and the second output feature vector are combined into a final output feature vector 106 by a final layer of the residual DCN model 104. The prediction model 108 receives the output feature vector 106 from the residual DCN model 104, and it generates a prediction vector based on the final output feature vector 106.

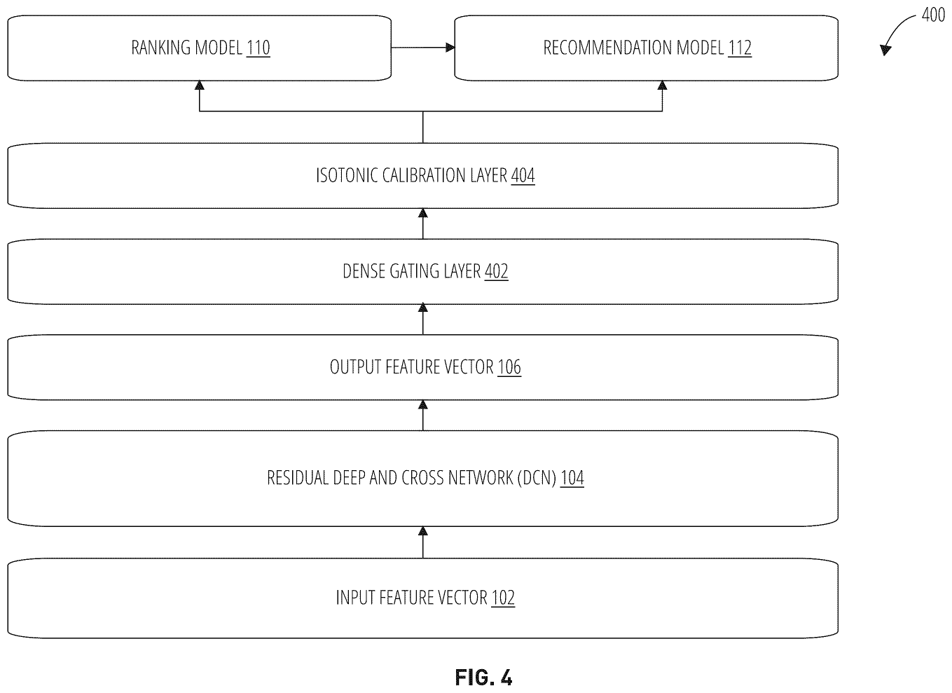

FIG. 4 illustrates a model architecture 400. The model architecture 400 is another example of a model architecture for a connections networking system. Specifically, the model architecture 400 is an example of a Feed Ranking Model Architecture. FIG. 4 presents a Feed Model architecture diagram to provide a flow of the model, and how different parts of the model are connected to each other. Note that placement of different modules may change the impact of the techniques significantly.

Similar to the model architecture 100, the model architecture 400 receives the input feature vector 102 and processes it via the residual DCN model 104 to generate the output feature vector 106. In addition, the model architecture 400 adds a dense gating layer 402 and an isotonic calibration layer 404. The output of the isotonic calibration layer 404 is fed into the ranking model 110 and/or the recommendation model 112 to produce a recommendation 114.

In one embodiment, for example, the input feature vector 102 for the model architecture 400 may comprise numeric and/or categorical features having dimension sizes of 1479 dimension, a categorical feature embedding lookup of 180 dimension, external dense embeddings of 400 dimension fed through a projection of 120 dimension, sparse ID embeddings of 150 dimension, and member history features of 100×150 dimension fed through a TransAct of 630 dimension. In this case, the input feature vector 102 may comprise 1929 dimension which feeds into an embedding layer 202 of the residual DCN model 104 with a 1929 dimension.

The model architecture 400 includes a dense gating layer 402. In the context of neural networks, a dense gating layer 402 is a component that controls the flow of information from one part of the network to another. It does so by learning which data is important to pass through and which to block or diminish in significance, based on the task at hand. Gating layers are needed to handle variable-length input sequences or manage the focus of attention within the data, such as in Long Short-Term Memory (LSTM) networks or Gated Recurrent Unit (GRU) networks. Essentially, gating mechanisms allow the network to dynamically adjust its information processing pathway, enhancing its ability to model complex patterns or sequences.

Although FIG. 4 illustrates the model architecture 400 as having a single dense gating layer 402, some neural networks may implement multiple dense gating layers 402 depending on a given application. In one embodiment, for example, the model architecture 400 may implement four dense gating layers 402, with a first dense gating layer 402 having a dimension size of 1024 dimension (with three dense swish layers of 1024 dimension each), a second dense gating layer 402 having a dimension size of 512 dimension, a third dense gating layer 402 having a dimension size of 256 dimension, and a fourth dense gating layer 402 having a dimension size of 128 dimension. The output of the fourth dense gating layer 402 is fed into the isotonic calibration layer 404.

The model architecture 400 further includes an isotonic calibration layer 404. As previously described, an ML model such as the prediction model 108, or a prediction model 108 embedded within the residual DCN model 104, may generate a prediction vector based on the final output from the residual DCN model 104. In some cases, the prediction vector needs calibration with ground truth values to increase accuracy of the predicted values. Therefore, the ML model (or a separate ML model) may implement a novel isotonic calibration layer 404 trained with the ML model to calibrate predicted values (e.g., predicted scores) with measured values (e.g., actual scores). The isotonic calibration layer 404 maps predicted values with intervals (e.g., score ranges) associated with constant measured values. For example, if a predicted value is 0.29, 0.30, and 0.31, and an interval has a measured valued of 0.25, the calibration model transforms all predicted values of 0.29, 0.30, and 0.31 to the measured value of 0.25. Rather than a post-processing operation, the isotonic calibration layer 404 is an actual neural network layer of the neural network used for calibration. This reduces the need to re-train the model for a given set of measured values associated with different entities, such as different advertising companies. This saves on training time and training data, while significantly improving predictive accuracy.

The isotonic calibration layer 404 calibrates prediction values for the prediction vector to form a calibrated prediction vector. The calibrated prediction vector is output to one or more output heads. In machine learning, an “output head” refers to the final layer or set of layers in a neural network model that are responsible for producing the model's output. This term is often used in the context of models that are designed to perform multiple tasks simultaneously or models that need to produce different types of outputs. The output head transforms the learned features and representations from the preceding layers of the model into a format that matches the desired output or prediction task. For example, if a model is designed to classify images into categories, the output head would be the layer that takes the features extracted by the earlier layers and applies a final transformation, such as a SoftMax function, to generate probabilities for each category. If the model is designed for regression, the output head might consist of a densely connected layer that produces a continuous value. In architectures designed for multiple tasks, there could be multiple output heads, each tailored to produce the correct type of output for its respective task. For instance, a model might have one output head for classifying objects in an image and another output head for localizing those objects within the image, each head being designed according to the specific requirements of these tasks.

FIG. 5 illustrates an example for the isotonic calibration layer 404. The isotonic calibration layer 404 may comprise a calibration model 502. The calibration model 502 may comprise a set of neural network layers 504.

The residual DCN model 104 or the prediction model 108 may generate a prediction vector 506 that the ranking model 110 and/or the recommendation model 112 may use to rank items or recommend items, respectively for a member of the connections networking system. The prediction vector 506 may comprise a set of predicted values 508.

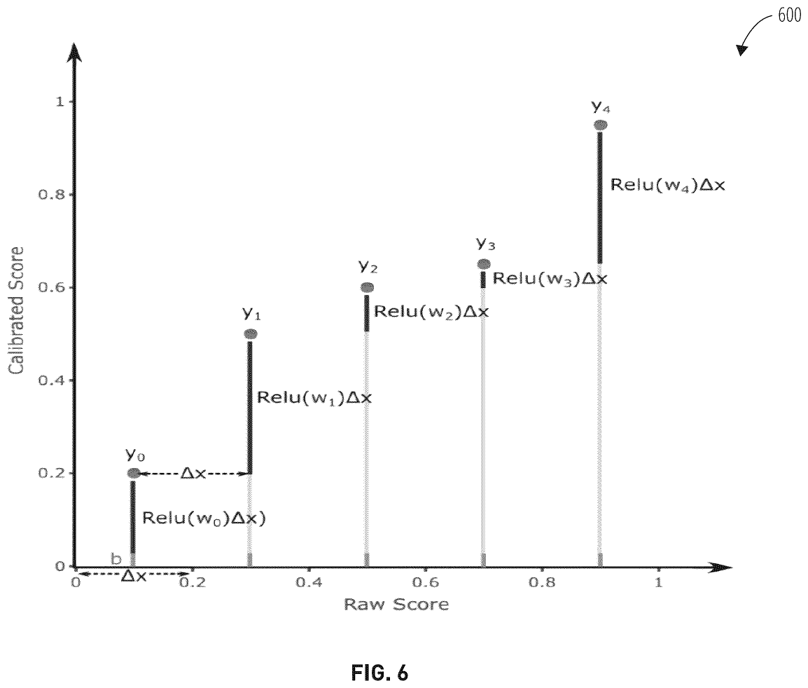

The isotonic calibration layer 404 is designed to calibrate the set of predicted values 508 from the prediction vector 506 using a calibration model 502 co-trained with the residual DCN model 104. The calibration model 502 may map the set of predicted values 508 to a corresponding set of intervals associated with a set of calibrated values 510. This process is described in more detail with reference to FIG. 6. The calibration model 502 uses an isotonic regression function that is monotonically increasing or decreasing to preserve an order of the set of predicted values 508. The calibration model 502 uses the set of neural network layers 504 to modify or replace the set of predicted values 508 with the set of calibrated values 510 based on the mapping. The calibrated values 510 are then passed to the ranking model 110 and/or the recommendation model 112.

FIG. 6 illustrates an isotonic layer representation 600 for an isotonic calibration layer 404 in a DNN. In one embodiment, for example, the isotonic calibration layer 404 may be a separate ML model, such as the calibration model 502. In one embodiment, for example, the isotonic calibration layer 404 may be part of another ML model, such as the prediction model 108 or the deep network 212 of the residual DCN model 104. Embodiments are not limited in this context.

Model calibration ensures that estimated class probabilities align with real-world occurrences, a crucial aspect for business success. For example, ads charging prices are linked to CTR probabilities, making accurate calibration essential. It also enables fair comparisons between different models, as the model score distribution can change when using different models or objectives. Traditionally, calibration is performed post-training using classic methods like Platt scaling and isotonic regression. However, these methods are not well-suited for deep neural network models due to limitations like parameter space constraints and incompatibility. Additionally, scalability becomes challenging when incorporating multiple features like device, channel, or item IDs into calibration.

To address the issues mentioned above, embodiments implement a customized isotonic regression layer that can be used as a native neural network layer to be co-trained with a deep neural network model to perform calibration. Similar to the isotonic regression, the isotonic calibration layer 404 follows the piece-wise fitting idea. It bucketizes the predicted values (probabilities are converted back to logits) by a given interval vᵢ and assigns a trainable weight wᵢ for each bucket, which are updated during the training with other network parameters, as shown in FIG. 6.

The isotonic property is guaranteed by using non-negative weights, which is achieved by using a Rectified Linear Unit (ReLU) activation function. To enhance its calibration power with multiple features, the weights can be combined with an embedding representation (a vector whose element is denoted as eᵢ) that derives from all calibration features. A final representation is shown in Equation (2) as follows:

$$Equation ( 2 )$$

$${y}_{cali} = {\sum }_{i = 0}^{i = k} Relu ( {e}_{i} + {w}_{i} ) \cdot {υ}_{1} + b , {υ}_{i} = \{ \begin{matrix}step , & if i < k \\ y - step \cdot k , & i = k\end{matrix} ,$$

$$k = arg {max}_{h} ( y - step \cdot j > 0 ) . ($$

For dense gating and large MLP, introducing personalized embeddings to global models helps introduce interactions among existing dense features, most of them being multi-dimensional count-based and categorical features. Embodiments flatten these multi-dimensional features into a singular dense vector, concatenating it with embeddings before transmitting it to the MLP layers for implicit interactions. A straightforward method to enhance gain was discovered by enlarging the width of each MLP layer, fostering more comprehensive interactions. For feed ranking, the largest MLP configuration experimented with offline was 4 layers of width 3500 each, sometimes referred to as a “Large MLP” (LMLP). Notably, gains manifest online exclusively when personalized embeddings are in play. However, this enhancement comes at the expense of increased scoring latency due to additional matrix computations. To address this issue, embodiments identifies an optimal configuration that maximizes gains within the latency budget.

Later, similar to Gating-Enhanced Deep Network (GateNet) for click-through rate prediction, embodiments implement a gating mechanism to hidden layers, such as dense gating layer 402. This mechanism regulates the flow of information to the next stage within the neural network, enhancing the learning process. This approach was most cost effective when applied to hidden layers, introducing only negligible extra matrix computation while consistently producing online lift. Additionally, some embodiments implement a sparse gated mixture of expert models (sMoE).

With respect to incremental training, large-scale recommender systems adapt to rapidly evolving ecosystems, constantly incorporating new content such as ads, news feed updates, and job postings. To keep pace with these changes, there is a temptation to use the last trained model as a starting point and continue training it with the latest data, a technique known as “warm start.” While this can improve training efficiency, it can also lead to a model that forgets previously learned information, a problem known as catastrophic forgetting. Incremental training, on the other hand, not only uses the previous model for weight initialization but also leverages it to create an informative regularization term.

Denote the current dataset at timestamp t as Dₜ, the last estimated weight vector as wₜ−1, the Hessian matrix with regard to wt−1 as Hₜ−1. The total loss up to timestamp tis approximated in Equation (3) as follows:

$${loss}_{{𝒟}_{t}} ( w ) + {λ}_{f} / 2 \times {( w - {w}_{t - 1} )}^{T} {ℋ}_{t - 1} ( w - {w}_{t - 1} ) \text{?} \qquad Equation ( 3 )$$

$$\text{?} \text{indicates text missing or illegible when filed}$$

In Equation (3), λ_{f} is the forgetting factor for adjusting the contribution from the past samples. In practice Hₜ−1 will be a very large matrix. Instead of computing Hₜ−1, embodiments only use the diagonal elements diag (Hₜ−1), which significantly reduces the storage and the computational cost. For large deep recommendation models, since the second order derivative computation is expensive, Empirical Fisher Information Matrix (FIM) is used to approximate the diagonal of the Hessian.

A typical incremental learning cycle comprises training one initial cold start model and training subsequent incrementally learnt models. To further mitigate catastrophic forgetting and address this issue, embodiments use both the prior model and the initial cold start model to initialize the weights and to calculate the regularization term. In this setting, the total loss presented in (2) is expressed in Equation (4) as follows:

$$Equation ( 4 )$$

$${loss}_{{𝒟}_{t}} ( w ) + {λ}_{f} / 2 \times [ {α ( w - {w}_{0} )}^{T} {ℋ}_{0} ( w - {w}_{0} ) + ( 1 - α ) {( w - {w}_{t - 1} )}^{T} {ℋ}_{t - 1} ( w - {w}_{t - 1} ) ] ,$$

In Equation (4), w₀ is the weight of the initial cold start model and H₀ is the Hessian with regard to w₀ over the cold start training data. Model weight w is initialized as aw0+(1−a)wt−1. The additional tunable parameter aϵ[0, 1] is referred to as cold weight as used herein. Positive cold weight continuously introduces the information of the cold start model to incremental learning. When cold weight is 0, then Equation (4) is the same as Equation (3).

With respect to member history modeling, in order to model member interactions with platform content, embodiments adopt an approach similar to behavior sequence transformer for e-commerce recommendations and Transformer-based Realtime User Action (TransAct) Model for recommendations. Embodiments create historical interaction sequences for each member, with item embeddings learned during optimization or via a separate model, like Deep Learning Recommendation Model for Personalization and Recommendation Systems. These item embeddings are concatenated with action embeddings and the embedding of the item currently being scored (early fusion). A two-layer Transformer-Encoder processes this sequence, and the maxpooling token is used as a feature in the ranking model. To enhance information, embodiments also consider the last five sequence steps, flatten and concatenate them as additional input features for the ranking model. To reduce latency, embodiments use shorter sequences and smaller feed-forward network dimensions within the transformer. In ablation experiments described below the history modeling is referred to as TransAct.

Findings show that a two-layer transformer with a feedforward dimension, which is half the input embedding size, delivers most relevance gains. While longer sequences improve relevance metrics, the added training and serving time did not justify extended history sequences.

With respect to the concepts of explore and exploit, the exploration versus exploitation dilemma is commonly faced in recommender systems. A simple utilization of member's historical feedback data (“exploitation”) to maximize immediate performance might hurt long term gain; while boosting new items (“exploration”) could help improve future performance at the cost of short term gain. To balance them, the traditional methods such as Upper Confidence Bounds (UCB), Thompson sampling are utilized; however, they cannot be efficiently applied to deep neural network models. To reduce the posterior probability computation cost and maintain certain representational power, embodiments adopt a method similar to a Neural Linear method, namely embodiments perform a Bayesian linear regression on the weights of the last layer of a neural network. Given a predicted value yᵢ for each input xᵢ is given by yᵢ=WZx, where W is the weights of last layer and Zx is the input to the last layer given input x. Given W embodiments apply a Bayesian linear regression to y with respect to Zx, and acquire the posterior probability of W, which is fed into Thompson Sampling. Unlike the method mentioned in previous work, embodiments do not independently train a model to learn a representation for the last layer. The posterior probability of W is incrementally updated at the end of each offline training in a given period, thus frequent re-trainings would capture new information timely. The technique has been applied to feed and online A/B testing showing relative +0.06% connections Daily Active Users.

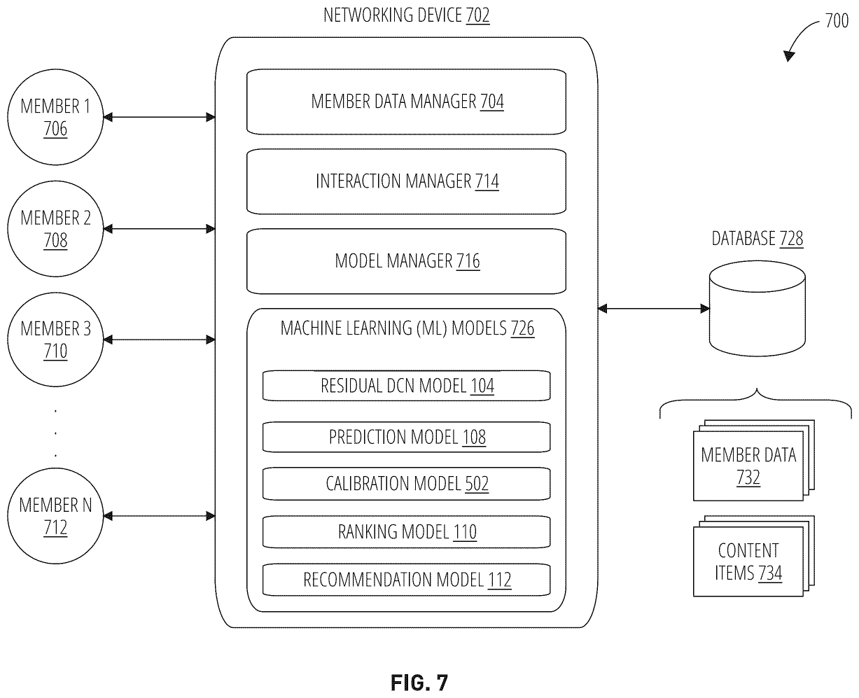

FIG. 7 illustrates a networking platform 700. The networking platform 700 is an example of networking platform components that is suitable for implementation by a connections networking system as described herein.

The networking platform 700 comprises a networking device 702. The networking device 702 comprises a member data manager 704, an interaction manager 714, a model manager 716, and one or more ML models 726. The ML models 726 may comprise a residual DCN model 104, a prediction model 108, a calibration model 502, a ranking model 110, and/or a recommendation model 112, as previously described.

The member data manager 704 manages member data 732 for one or more members 1-N, such as member 1 706, member 2 708, member 3 710, and member N 712, where N represents any positive integer. The member data 732 may be stored by the networking device 702 or an external database 728. The database 728 may store one or more content items 734.

The interaction manager 714 may monitor and collect interaction data associated with one or more members 1-N. The interaction data represents interactions between a member 1-N and an interface of the networking device 702, such as graphical user interface (GUI) presented by a web site generated by the networking device 702 for the networking platform 700. Interaction data between a member 1-N and the networking device 702 of the networking platform 700 pertains to the recorded activities and communications that occur when the member interacts with the networking device 702. Collectively, this interaction data is utilized by the connections networking system to enhance user experience, facilitate networking opportunities, personalize content delivery, and improve system functionalities, such as recommendation algorithms and connections development tools. The interaction manager 714 stores the interaction data as part of the member data 732.

In the context of the networking platform 700, interaction data helps shape member experience and enhances system functionality. This data encompasses a range of member activities and interactions as captured by the networking device 702. Beginning with profile visits, the interaction manager 714 records which profiles have been viewed by the member, as well as tracking who has visited the member's own profile. This bidirectional visibility offers both parties insights into potential networking and collaborative opportunities. Search queries form another critical part of the interaction data. Members routinely engage with the networking device 702 search function to discover jobs, connect with other connections, or seek out information related to their connection's interests. The networking device 702 captures these search terms, providing a valuable window into the member's intent and areas of interest. Content engagement reveals how members interact with various forms of content on the platform. Whether it's through engaging with posts, articles, comments, or expressing themselves via likes, shares, and reactions, each action is logged by the networking device 702. This data not only reflects the member's interests and preferences but also fosters a vibrant community discourse. Connection requests hold significant value, capturing detailed sent and received networking propositions. This includes tracking of requests that are accepted, pending, or declined, painting a comprehensive picture of networking efforts and outcomes. Messaging data records the direct interactions between the members. This includes the exchange of messages, capturing the content, timing, and identifiers of the parties involved, thereby facilitating direct communication within the connections community. The interaction manager 714 also monitors job applications initiated by users through the networking device 702. This includes the tracking of application statuses and any direct communications with potential employers, offering users a streamlined job search experience. Moreover, recommendations and endorsements provide insight into the member's connections standing within the networking platform 700. Data relating to connections skills endorsements, written recommendations, and the receipt of badges or other forms of recognition speak volumes about the member's reputation and expertise. Lastly, notification interactions are tracked, including the member's responses to system-generated reminders, updates, and alerts. This not only enhances member engagement but also ensures that members remain informed and responsive to relevant activities within their connections network. In sum, the collection and analysis of interaction data between members and the networking platform 700 constitute a rich source of insights. These interactions facilitate the creation of a dynamic and responsive networking device 702 that caters to the connections needs and aspirations of its members, thereby reinforcing the value and utility of the networking platform 700.

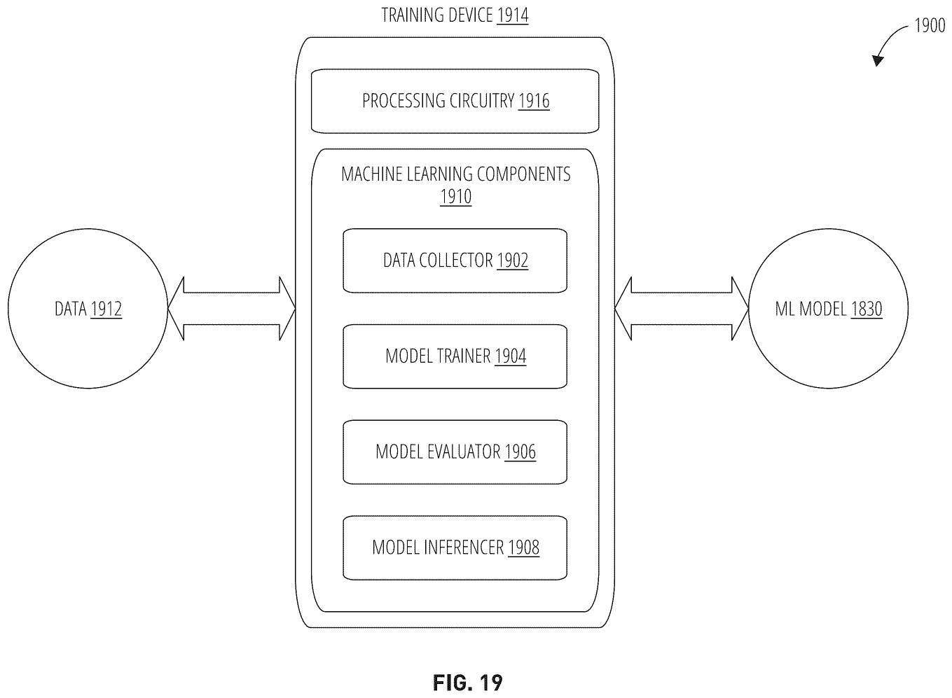

The model manager 716 may manage training operations and/or inferencing operations for the ML models 726. For training, the model manager 716 may implement a training system to train the residual DCN model 104. The training system accesses a training dataset comprising a set of datapoints to train the set of cross layers 1-X of the cross network 204 for the residual DCN model 104. The set of datapoints may comprise input feature vectors 102 and output feature vectors 106. The input feature vectors 102 may represent a set of features for a connections networking system and the output feature vectors 106 may represent a set of feature crosses for the set of features. The training system generates a candidate output feature vector for an input feature vector 102 of a datapoint by the set of cross layers 1-X of the cross network 204. The training system determines a difference value between the candidate output feature vector and an output feature vector 106 associated with the input feature vector 102 of the datapoint. The training system updates the attention parameters (e.g., weights and/or biases) for the attention data structures 324 of the attention cross layer 300 based on the difference value and a loss function. The training system may perform similar training operations for the other ML models 726, such as the prediction model 108, the calibration model 502, the ranking model 110, and/or the recommendation model 112. An example of a training system is described in more detail with reference to FIG. 19.

Once the model manager 716 trains the ML models 726, the model manager 716 may control or manage inferencing operations for the 702. For example, the model manager 716 may monitor interaction data associated with a member N of the networking platform 700 and select the member N to deliver a networking service to the member N. For example, the model manager 716 may receive interaction data for the member N, retrieve member data 732 associated with member N from the database 728, process the member data 732 for member N using one or more of the ML models 726, select one or more content items 734 from the database 728 that may be of interest to the member N based on output of the ML models 726, and deliver the one or more content items 734 to an electronic device associated with the member N.

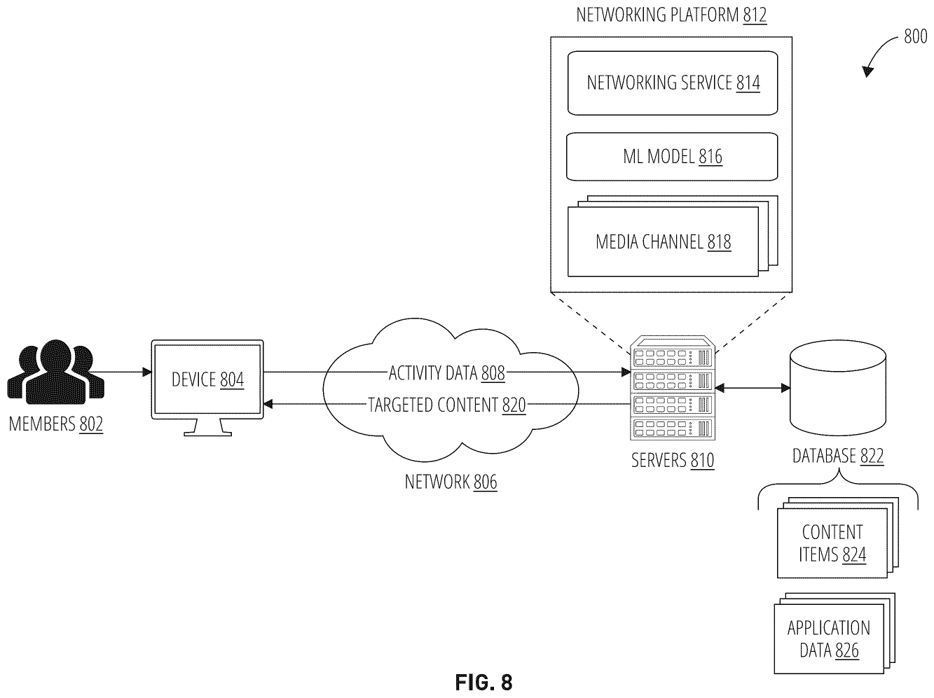

FIG. 8 illustrates a networking system 800. The networking system 800 is an example of a social networking system or a connections networking system designed to deliver targeted content 820 to one or more members 802 using, for example, the networking platform 700. The targeted content 820 may comprise, for example, recommendations, advertisements, content, messages, suggestions, hyperlinks, files, job postings, articles, and any other content offered by the networking system 800.

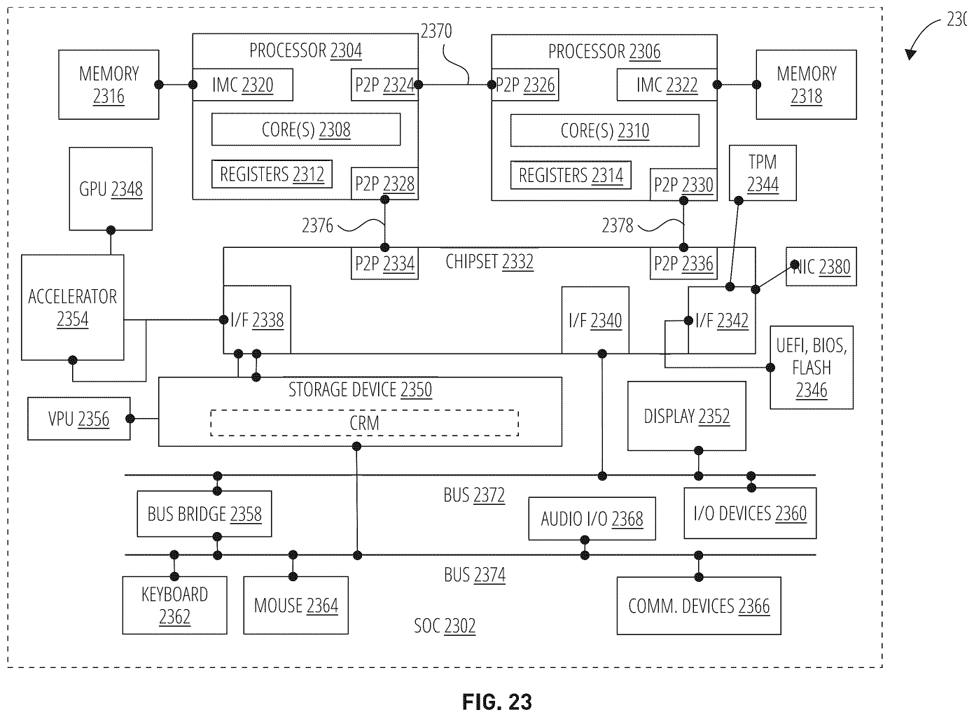

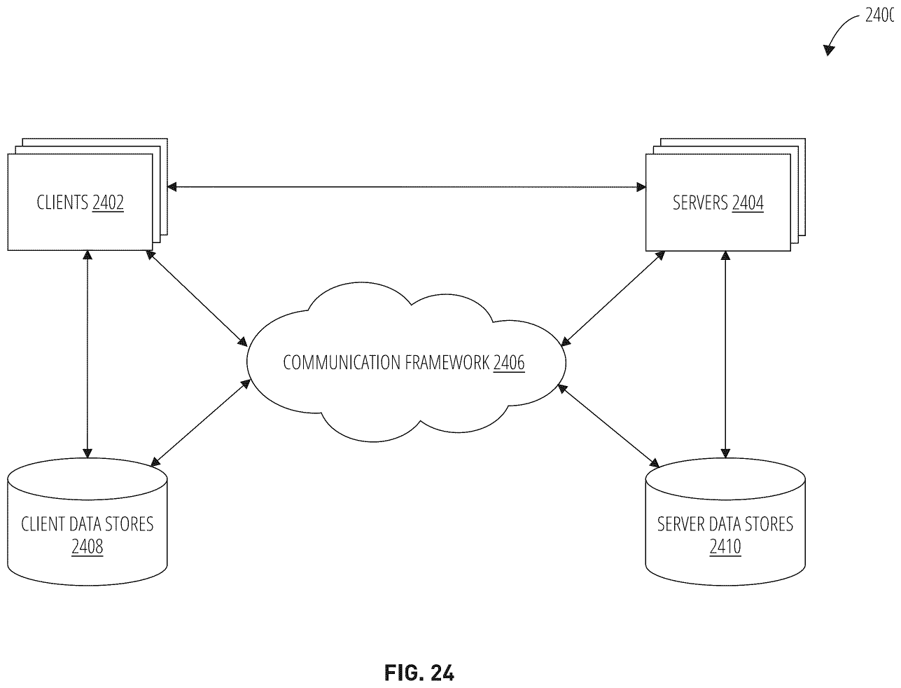

The networking system 800 comprises a device 804, a set of one or more servers 810, and a database 822. The device 804 and the servers 810 may communicate information via a network 806. The device 804 may comprise an electronic device, such as a smartwatch, smartphone, tablet, laptop computer, desktop computer, and so forth. The servers 810 may be implemented as part of a data center, such as a cloud computing system. The device 804 and the servers 810 may be implemented using an architecture as described in FIG. 23. The network 806 may be implemented using an architecture as described in FIG. 24. Embodiments are not limited to these example implementations.

The one or more servers 810 implements a networking platform 812. In one embodiment, the networking platform 812 includes at least one processor; at least one memory including instructions executable by the at least one processor; and an ML model 816 comprising parameters and/or hyperparameters stored in the at least one memory. In one embodiment, for example, the ML model 816 comprises an example of a residual DCN for an AI system implemented by the networking system 800 to offer a networking service 814 by the networking platform 812 as described herein. The networking service 814 may select one or more content items 824 for delivery as targeted content 820 over one or more media channels 818 to the device 804. A members 802 may interact with a graphical user interface (GUI) to access the targeted content 820 for presentation on the device 804.

The servers 810 may include networking platform 812 implementing a networking service 814 that is designed for providing a networking service to a members 802 of the networking platform 812. Connections networking platforms offer a wide range of networking services to facilitate connections, career development, and knowledge sharing. Some examples of a networking service 814 offered by the networking platform 812 include without limitation: (1) users can create a connections profile to showcase their skills, work experience, education, and connections accomplishments; (2) users can connect with colleagues, industry connections, and potential employers to expand their connections network; (3) messaging capabilities for direct communication between users, facilitating connections conversations and networking opportunities; (4) users can join and participate in industry-specific groups and communities to engage in discussions, share insights, and network with like-minded connections; (5) search job listings and recruiting tools for users to search for employment opportunities, apply for jobs, and connect with talent; (6) users can share industry-related content, articles, and connections updates to showcase expertise and engage with their network; and (7) access learning resources, courses, and training programs to support ongoing connections development and skill enhancement. These networking services are designed to help connections connect, collaborate, and grow their careers. Embodiments are not limited to these examples.

In an example process, the networking platform 812 obtains activity data 808 from a members 802 via the device 804. The members 802 interacts with the networking platform 812 via a user interface of the networking platform 812. In some cases, portions of the user interface are displayed on a personal machine or device 804 of the members 802. The activity data 808 represents various actions, activities or behaviors of the members 802. For example, activity data 808 may represent data collected as the members 802 interacts with content items 824 of the database 822 served via the servers 810. Session data is any activity data 808 collected during a defined session time window, such as activity of the user over a 24 h period or some other time interval. For example, the members 802 may interact with the device 804 to communicate with networking platform 812 of one or more of the servers 810 to access one or more content items 824 stored by the database 822. The members 802 may perform various activities, such as browsing a web site, searching for a job posting, reading content, watching a streaming video, messaging other members, or engaging in electronic commerce. The session data, including the activity data 808, is transferred between the device 804 and the servers 810.

More particularly, the networking platform 812 comprises the networking service 814, which includes or accesses an ML model 816 such as a residual DCN, and data for one or more media channels 818. The networking service 814 is responsible for creation of targeted content 820 based on activity data 808 and/or session data associated with the members 802. The networking service 814 uses the ML model 816 to support such activities. The networking service 814 then targets delivery of specific messages to users within user segments, such as targeted content 820 for the members 802, over one or more media channels 818. The targeted content 820 is a content item that is relevant to the members 802 or a user segment, such as messages, predictions, recommendations, advertisements, or suggestions to improve user experience.

The targeted content 820 is delivered through one or more of the media channels 818. A media channel refers to a specific platform or medium through which targeted content, such as advertisements, are disseminated to a target user. Media channels 818 can include various forms of digital and traditional media such as websites, mobile applications, social media platforms, television, radio, print publications, and outdoor advertising spaces. Each media channel possesses its own unique characteristics and user demographics, allowing advertisers to tailor their messages to reach the desired target user effectively. message provider, such as advertisers, often choose certain media channels based on factors such as user engagement, reach, cost, and the compatibility of the channel with their target market. An example of the media channel 818 is a social media platform or a connections media platform, or some other mode of information transfer within the platform.

The networking platform 812 or components thereof are implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) can also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a super computer, or any other suitable processing apparatus.

Database 822 is an organized collection of data. For example, the database 822 stores data in a specified format known as a schema. The database 822 can be structured as a single database, a distributed database, multiple distributed databases, or an emergency backup database. In some cases, a database controller manages data storage and processing in database 822. In some cases, a user interacts with the database controller. In other cases, the database controller operates automatically without user interaction. The database 822 is configured to store various content items 824. The content items 824 include any multimedia information suitable for presentation by the device 804, such as HTML code to present websites, text, images, video, messages, advertisements, and so forth. In addition, the database 822 may store application data 826. The application data 826 comprises information and data used by the networking platform 812. For example, database client device 1802 is configured to store user session data, profiles, embeddings, budgets, cached application programming interface (API) requests, machine learning model parameters, training data, and other data.

Network 806 facilitates the transfer of information between networking platform 812, database 822, and members 802. Network 806 is a computer network configured to provide on-demand availability of computer system resources, such as data storage and computing power. In some examples, the network 806 provides resources without active management by the members 802. The network 806 includes data centers available to many users over the Internet. Some large cloud networks have functions distributed over multiple locations from central servers. A server is designated an edge server if it has a direct or close connection to a members 802. In some cases, a cloud is limited to a single organization. In other examples, the cloud is available to many organizations. In one example, the network 806 includes a multi-layer communications network comprising multiple edge routers and core routers. In another example, the network 806 is based on a local collection of switches in a single physical location.

Operations for the disclosed embodiments may be further described with reference to the following figures. Some of the figures may include a logic flow. Although such figures presented herein may include a particular logic flow, it can be appreciated that the logic flow merely provides an example of how the general functionality as described herein can be implemented. Further, a given logic flow does not necessarily have to be executed in the order presented unless otherwise indicated. Moreover, not all acts illustrated in a logic flow may be required in some embodiments. In addition, the given logic flow may be implemented by a hardware element, a software element executed by a processor, or any combination thereof. The embodiments are not limited in this context.

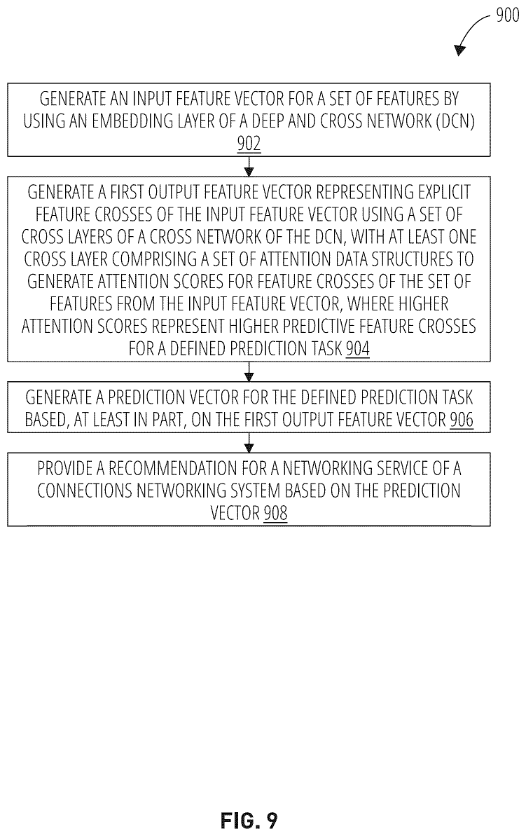

FIG. 9 illustrates an embodiment of a logic flow 900. The logic flow 900 may be representative of some or all of the operations executed by one or more embodiments described herein. For example, the logic flow 900 may include some or all of the operations performed by devices or entities within the networking platform 700, such as the networking device 702. More particularly, the logic flow 1000 illustrates an example where the networking device 702 performs a set of inferencing operations using the model architecture 100 and/or the model architecture 400 having the residual DCN model 104.

In block 902, logic flow 900 generates an input feature vector for a set of features by using an embedding layer of a deep and cross network (DCN). In block 904, logic flow 900 generates a first output feature vector representing explicit feature crosses of the input feature vector using a set of cross layers of a cross network of the DCN, with at least one cross layer comprising a set of attention data structures to generate attention scores for feature crosses of the set of features from the input feature vector, where higher attention scores represent higher predictive feature crosses for a defined prediction task. In block 906, logic flow 900 generates a prediction vector for the defined prediction task based, at least in part, on the first output feature vector. In block 908, logic flow 900 provides a recommendation for a networking service of a connections networking system based on the prediction vector.

By way of example, an embedding layer 202 of a residual DCN model 104 may generate and/or receive an input feature vector 102 for a set of features. The residual DCN model 104 may generate a first output feature vector 106 representing explicit feature crosses of the input feature vector 102 using a set of cross layers 1-X of a cross network 204 of the residual DCN model 104, with at least one cross layer comprising an attention cross layer 300 comprising a set of attention data structures 324 to generate attention scores for feature crosses of the set of features from the input feature vector 102, where higher attention scores represent higher predictive feature crosses for a defined prediction task. A prediction model 108 may generate a prediction vector 506 for the defined prediction task based, at least in part, on the first output feature vector 106, and provide a recommendation for a networking service 814 of a connections networking system 800 based on the prediction vector 506.

In one embodiment, for example, the set of features comprises one or more numerical features, categorical features, categorical feature embeddings from a lookup table, dense embeddings, sparse identifier embeddings, or member history features defined for the connections networking system.

In one embodiment, for example, the at least one cross layer such as attention cross layer 300 comprises a set of low-rank matrices representing low-rank approximations of a full-rank weight matrix 302, the set of low-rank matrices comprising a first low-rank matrix 304 representing a first subspace of the full-rank weight matrix 302 and a second low-rank matrix 306 representing a second subspace of the full-rank weight matrix 302.

In one embodiment, for example, the set of attention data structures 324 may comprise an attention score matrix 316 and a value matrix 314, the attention score matrix 316 comprising a combination of a query matrix 310 and a key matrix 312, and a residual connection 320 comprising a skip connection.

In one embodiment, for example, the embedding layer 202 of the cross network 204 may generate a cross layer input feature vector 308 based on the input feature vector 102, multiply the cross layer input feature vector 308 with a first low-rank matrix (e.g., first low-rank matrix 304) of a set of low-rank matrices to form a query matrix 310, multiply the cross layer input feature vector 308 with the first low-rank matrix (e.g., first low-rank matrix 304) of the set of low-rank matrices to form a key matrix 312, and multiplying the query matrix 310 and the key matrix 312 to form an attention score matrix 316 for the attention cross layer 300.

In one embodiment, for example, the attention cross layer 300 may generate a cross layer output feature vector 322 using a set of operations comprising multiplying a first cross layer input feature vector 308 with a first low-rank matrix (e.g., first low-rank matrix 304) of a set of low-rank matrices and an attention score matrix 316 to form a first intermediate result, multiplying the first intermediate result with a second low-rank matrix (e.g., second low-rank matrix 306) of the set of low-rank matrices to form a second intermediate result, adding a bias vector 318 to the second intermediate result to form a third intermediate result, multiplying the third intermediate result with the input feature vector 102 to form a fourth intermediate result, and adding the first cross layer input feature vector 308 to the fourth intermediate result via a residual connection 320 to form the cross layer output feature vector 322, the residual connection 320 comprising a skip connection.

In one embodiment, for example, a first attention cross layer 300 may generate a first cross layer output feature vector 322 based on the input feature vector 102 and a first cross layer input feature vector 308, generate a second cross layer output feature vector 322 by a second attention cross layer 300 based on the input feature vector 102 and the first cross layer output feature vector 322, and provide the second cross layer output feature vector 322 to an output layer of the cross network 204.

In one embodiment, for example, a deep network 212 of the residual DCN model 104 may generate a second output feature vector 106 representing implicit feature crosses of the input feature vector 102 using a DNN, and combine the first output feature vector 106 and the second output feature vector 106 into a final output feature vector 106 by a final layer of the residual DCN model 104. The residual DCN model 104 and/or the prediction model 108 may generate the prediction vector 506 based on the final output feature vector 106.

In one embodiment, for example, a ranking model 110 may rank content items 824 for a feed ranking model of the connections networking system 800 based on the prediction vector 506, the prediction vector 506 comprising a probability distribution indicating a probability of a like, a comment, a share, a vote, a long dwell, or a click for a content item.

In one embodiment, for example, the ranking model 110 may rank advertisements for an advertisement ranking model of the connections networking system based on the prediction vector, the prediction vector comprising a probability of a click-through-rate (CTR) for an advertisement.

In one embodiment, for example, the ranking model 110 may rank job recommendations for a job ranking model of the connections networking system 800 based on the prediction vector 506, the prediction vector 506 comprising a probability of a job application for a job recommendation.

In one embodiment, for example, the networking system 800 may deliver one or more content items 824 for presentation on a graphical user interface (GUI) of an electronic device 804, the content item comprising a feed content item, an advertisement, or a job recommendation.

In one embodiment, for example, the cross network 204 of the residual DCN model 104 generates the first output feature vector 106 and the deep network 212 (e.g., a DNN) of the residual DCN model 104 generates the second output feature vector 106 in a stacked structure 200 or a parallel structure 222.

In one embodiment, for example, a dense gating layer 402 may receive the final output feature vector 106, which gates portions of the final output feature vector 106 based on a gating value, and generates a gated feature vector based on the non-gated portions of the output feature vector 106.

In one embodiment, for example, a calibration model 502 may calibrate a set of predicted values from the prediction vector 506, where the calibration model 502 is co-trained with the residual DCN model 104 using operations comprising mapping the set of predicted values 508 from the prediction vector 506 to a corresponding set of intervals associated with a set of calibrated values 510 (e.g., measured values) using an isotonic calibration layer 404 of the calibration model 502, the isotonic calibration layer 404 using an isotonic regression function that is monotonically increasing or decreasing to preserve an order of the set of prediction predicted values 508, and replacing the set of prediction predicted values 508 with the set of calibrated values 510 (e.g., measured values) based on the mapping.

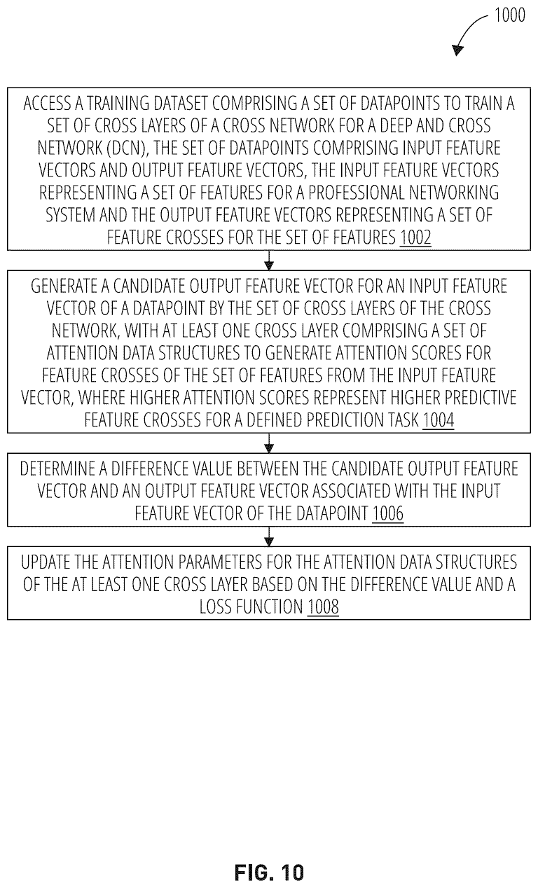

FIG. 10 illustrates an embodiment of a logic flow 1000. The logic flow 1000 may be representative of some or all of the operations executed by one or more embodiments described herein. For example, the logic flow 1000 may include some or all of the operations performed by devices or entities within the networking platform 700, such as the networking device 702. More particularly, the logic flow 1000 illustrates an example where the networking device 702 performs a set of training operations using the model architecture 100 and/or the model architecture 400 having the residual DCN model 104.

In block 1002, logic flow 1000 accesses a training dataset comprising a set of datapoints to train a set of cross layers of a cross network for a deep and cross network (DCN), the set of datapoints comprising input feature vectors and output feature vectors, the input feature vectors representing a set of features for a connections networking system and the output feature vectors representing a set of feature crosses for the set of features. In block 1004, logic flow 1000 generates a candidate output feature vector for an input feature vector of a datapoint by the set of cross layers of the cross network, with at least one cross layer comprising a set of attention data structures to generate attention scores for feature crosses of the set of features from the input feature vector, where higher attention scores represent higher predictive feature crosses for a defined prediction task. In block 1006, logic flow 1000 determines a difference value between the candidate output feature vector and an output feature vector associated with the input feature vector of the datapoint. In block 1008, logic flow 1000 updates the attention parameters for the attention data structures of the at least one cross layer based on the difference value and a loss function.

The logic flow 1000 may also generate the cross layer using a set of operations comprising transforming a full-rank matrix to a set of low-rank matrices using low-rank approximation, generating a subset of the attention data structures from a first low-rank matrix of the set of low-rank matrices, the subset of attention data structures comprising a value matrix, a query matrix, and a key matrix, and generating an attention score matrix from the query matrix and the key matrix.

The logic flow 1000 may also perform operations such as identifying datapoints comprising sparse vectors representing categorical features encoded with one-hot encoding from the training dataset, replacing the identified datapoints with defined feature embeddings having a lower number of dimensions than a dimension of the identified datapoints to form a modified training dataset, and training the set of cross layers for the DCN with the modified training dataset.

The logic flow 1000 may also perform operations such as generating a cross layer input feature vector based on the input feature vector, multiplying the cross layer input feature vector with a first low-rank matrix of a set of low-rank matrices to form a query matrix, multiplying the cross layer input feature vector with the first low-rank matrix of the set of low-rank matrices to form a key matrix, and multiplying the query matrix and the key matrix to form an attention score matrix for the at least one cross layer.

The logic flow 1000 may also perform operations such as generating a cross layer output feature vector by the at least one cross layer using a set of operations comprising multiplying a first cross layer input feature vector with a first low-rank matrix of a set of low-rank matrices and an attention score matrix to form a first intermediate result, multiplying the first intermediate result with a second low-rank matrix of the set of low-rank matrices to form a second intermediate result, adding a bias vector to the second intermediate result to form a third intermediate result, multiplying the third intermediate result with an input feature vector to form a fourth intermediate result, and adding the first cross layer input feature vector to the fourth intermediate result via the residual connection to form the cross layer output feature vector, the residual connection comprising a skip connection.

The logic flow 1000 may also perform operations such as generating the candidate output feature vector for the input feature vector of the datapoint by the set of cross layers of the cross network using a set of operations comprising generating a first cross layer output feature vector by a first cross layer based on an input feature vector and a first cross layer input feature vector, generating a second cross layer output feature vector by a second cross layer based on the input feature vector and the first cross layer output feature vector, and providing the second cross layer output feature vector to an output layer of the cross network.

The logic flow 1000 may also perform operations such as training a deep neural network (DNN) for the DCN using the set of datapoints and a loss function in sequence with the cross network or in parallel with the cross network.

The logic flow 1000 may also perform operations such as training an isotonic calibration layer of a calibration model using the set of datapoints using a set of operations comprising generating a candidate prediction vector based, at least in part, on the candidate output feature vector, mapping a set of prediction values from the candidate prediction vector to a corresponding set of intervals associated with a set of measured values using the isotonic calibration layer of the calibration model, the isotonic calibration layer using an isotonic regression function that is monotonically increasing or decreasing to preserve an order of the set of prediction values, determining difference values between the mapping of the set of prediction values from the candidate prediction vector and a measured mapping of a set of prediction values from a prediction vector of a datapoint, and updating parameters for the isotonic calibration layer based on the difference values and a loss function.

The logic flow 1000 may also perform operations such as generating a set of evaluation values to measure performance of the trained cross network of the DCN according to a set of evaluation metrics, and fine-tuning the trained cross network of the DCN based on the set of evaluation values.

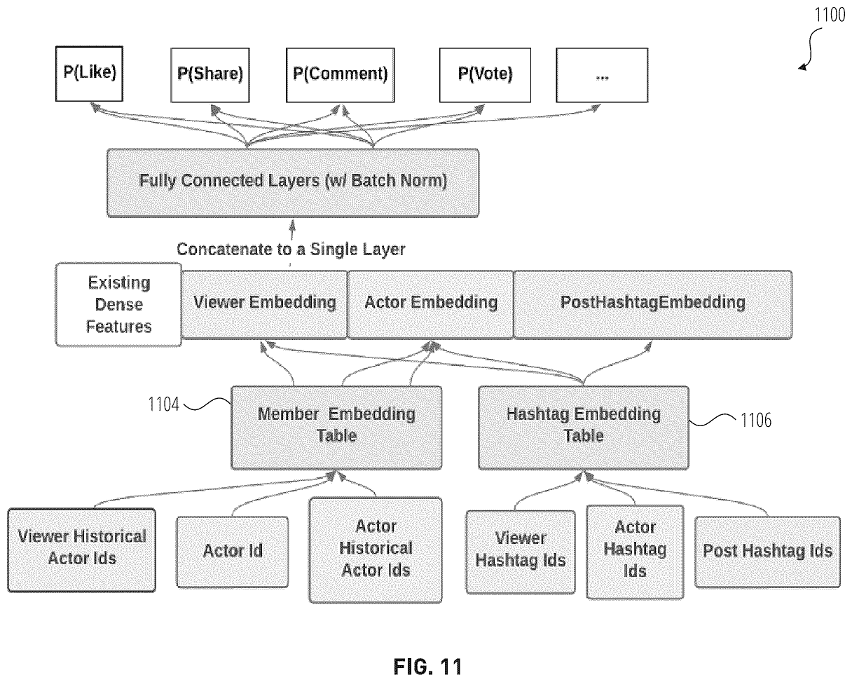

FIG. 11 illustrates a large ranking model 1100. The large ranking model 1100 comprises an example of a large ranking model for an AI system, such as networking system 800. Specifically, the large ranking model 1100 is an example of a main feed ranking model suitable for a networking platform as described herein.

In general, a large ranking model is a type of model designed to rank items based on their relevance to a specific query, user activity, or user preferences. These models are commonly used in information retrieval systems, recommendation systems, and search engines to provide personalized and relevant results to users. Large ranking models are often trained using large-scale datasets and utilize techniques such as learning to rank, which involves optimizing the model parameters to better predict the relevance of items for a given query or user. These models typically consider various factors such as the user's historical behavior, item features, and contextual information to generate rankings that best match user activity, user preferences or satisfy a query. Large ranking models can involve complex architectures, such as deep learning-based models or ensemble methods, to handle the challenges of ranking a large number of items with high dimensionality and diverse features.

In the context of a networking platform, the large ranking model 1100 is used to deliver networking platform services to members 802 of the networking platform 700. In one embodiment, for example, the large ranking model 1100 is implemented as a feed ranking model. For example, the large ranking model 1100 depicted in FIG. 11 is an example of a contribution tower of a main feed ranking model. It may be appreciated that particular architecture components to implement the large ranking model 1100 may vary based on a particular use case.

As depicted in FIG. 11, the large ranking model 1100 is a primary feed ranking model that employs a point-wise ranking approach, predicting multiple probabilities of contributions including like, comment, share, vote, and long dwell and click for each <member, candidate post> pair. These predictions are linearly combined to generate the final post score. A TensorFlow (TF) model with multi-task learning (MTL) architecture generates these probabilities in two towers: (1) a click tower for probabilities of click and long dwell; and (2) a contribution tower for contribution and related predictions. Both towers use the same set of dense features normalized based on their distribution, and apply multiple fully-connected layers. Sparse identifier (ID) embedding features are transformed into dense embeddings through lookup in embedding tables of a member embedding table 1104 and a hashtag embedding table 1106 as shown in FIG. 11. FIG. 11 provides an example diagram of how different architectures are connected together into a single model.

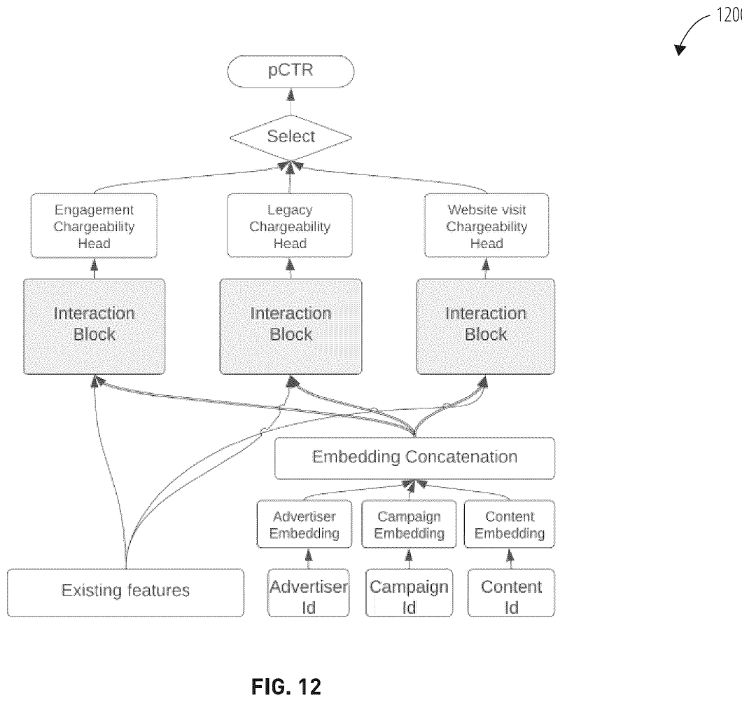

FIG. 12 illustrates a large ranking model 1200. The large ranking model 1200 comprises an example of a large ranking model for an AI system, such as networking system 800. Specifically, the large ranking model 1200 is an example of an advertising (ads) chargeability-based multi-task model suitable for a networking platform as described herein.

FIG. 12 depicts a model architecture suitable for advertising CTR prediction. At various networking platforms, advertising selection relies on CTR prediction, estimating the likelihood of member clicks on recommended ads. This CTR probability informs ad auctions for displaying ads to members. Advertisers customize chargeable clicks for campaigns, such as some advertisers consider social interaction such as “like”, “comment” as chargeable clicks while others only consider visiting ads websites as clicks. Usually only positive customized chargeable clicks are treated as positive labels. To better capture user interest, embodiments implement a CTR prediction model as a chargeability-based multi-task learning (MTL) model with 3 heads that correspond to 3 chargeability categorizations where similar chargeable definitions are grouped together regardless of advertiser customization. Each head employs independent interaction blocks such as MLP and DCN-V2 blocks. The loss function combines head-specific losses. For features, besides traditional features from members and advertisers, embodiments incorporate ID features to represent advertisers, campaigns, and advertisements.

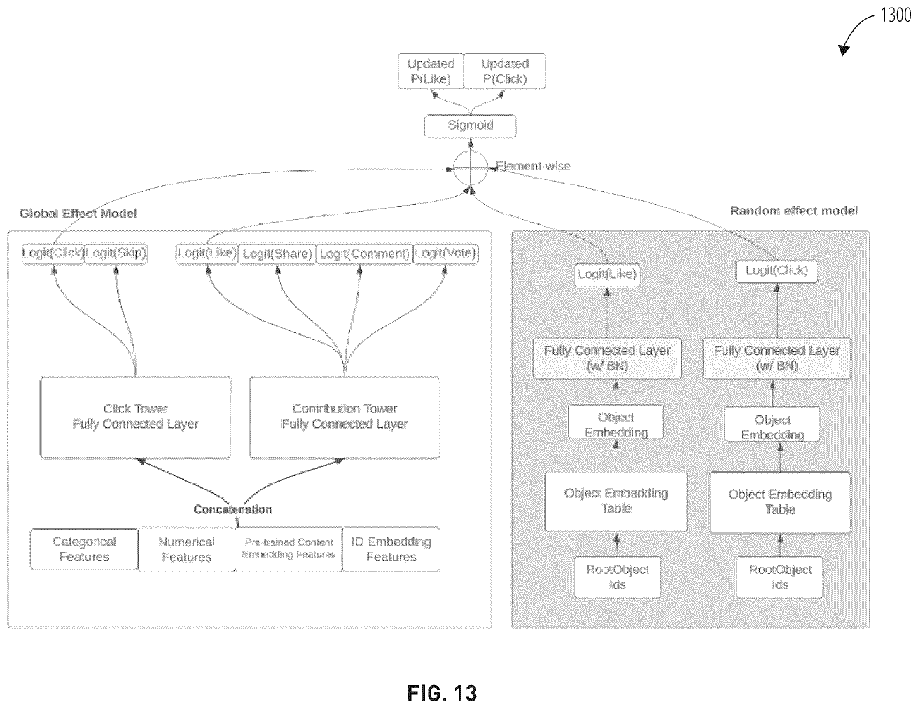

FIG. 13 illustrates a root object wide model 1300. The root object wide model 1300 is an example of a wide popularity features for an AI system, such as the ML model 816 of the networking system 800.

The root object wide model 1300 is a ranking model that combines a global model with billions of parameters to capture broad trends and a random effect model to handle variations among individual items, assigning unique values reflecting their popularity among users. Due to a networking platform's dynamic nature, random effect models receive more frequent training to adapt to shifting trends. For identifiers with high volatility and short-lived posts, known as Root Object ID, embodiments use a specialized root-object (RO) model. This model is trained every 8 hours with the latest data to approximate the residuals between the main model's predictions and actual labels. Due to higher coverage of labels embodiments use Likes and Clicks within the root object wide model 1300. The final prediction of the root object wide model 1300, denoted as y final, hinges on the summation of logits derived from the global model and the random effect model. It is computed in Equation (5) as follows:

$${y}_{final} = σ ( log it ( {y}_{global \_ effect} ) + log it ( {y}_{random \_ effect} ) ) , \qquad Equation ( 5 )$$

where σ signifies the sigmoid function.

Large embedding tables aid in the item ID learning process. Embodiments incorporate an explore/exploit algorithm alongside RO Wide scores, improving the Feed user experience with +0.17% relative increase in engaged daily active users (DAU) and +0.26% relative uplift in Feed Sessions.

Multi-task Learning (MTL) is pivotal for enhancing modern feed ranking systems, particularly in Second Pass Ranking (SPR). MTL enables SPR systems to optimize various ranking criteria simultaneously, including user engagement metrics, content relevance, and personalization. Our exploration of MTL in SPR has involved various model architectures designed to improve task-specific learning, each with unique features and benefits: (1) Hard Parameter Sharing: involves sharing parameters directly across tasks, serving as a baseline; and (2) Grouping Strategy: tasks are grouped based on similarity, such as positive/negative ratio or semantic content. For instance, tasks like ‘Like’ and ‘Contribution’ are grouped together due to their higher positive rates, while ‘Comment’ and ‘Share’ are grouped separately with lower positive rates. Embodiments implement common approaches, including Multi-Gate Mixture-Of-Experts (MMoE) and Product-Based Linear Embedding (PLE). In experiments, the Grouping Strategy showed a modest improvement in metrics with only a slight increase in model parameters, as shown in Table 1.

TABLE 1
Performance comparison of MTL models.

| Model | Contributions |
|---|---|
| Hard Parameter Sharing | baseline |
| Grouping Strategy | +0.75% |
| MMOE | +1.19% |
| PLE | +1.34% |

On the other hand, MME and PLE, while offering significant performance boosts, expanded the parameter count by 3×-10×, depending on the expert configuration, posing challenges for large-scale online deployment.

Dwell time, reflecting member content interaction duration, provides valuable insights into member's behavior and preferences. Embodiments introduce a “long dwell” signal to detect passive content consumption on the networking platform feed. Implementing this signal effectively allows the capture of passive but positive engagement. Model Dwell time presented technical challenges: (1) Noisy dwell time data made direct prediction or logarithmic prediction unsuitable due to high volatility; (2) Static threshold identification for “long dwell” could not adapt to evolving user preferences, manual thresholds lacked consistency and flexibility; and (3) Fixed thresholds could bias towards content with longer dwell times, conflicting with our goal of promoting engaging posts across all content types on networking platform feed.

To address these challenges, embodiments implement a “long dwell” binary classifier predicting whether there is more time spent on a post than a specific percentile (e.g., 90th percentile). Specific percentiles are determined based on contextual features such as ranking position, content type, and platform, forming clusters for long-dwell threshold setting and enhancing training data. By daily measuring cluster distributions, embodiments capture evolving member consumption patterns and reduce bias and noise in the dwell time signal. The model operates within a multi-task multi-class framework, resulting in relative improvements of a 0.8% in overall time spent, a 1% boost in time spent per post, and a 0.2% increase in member sessions.

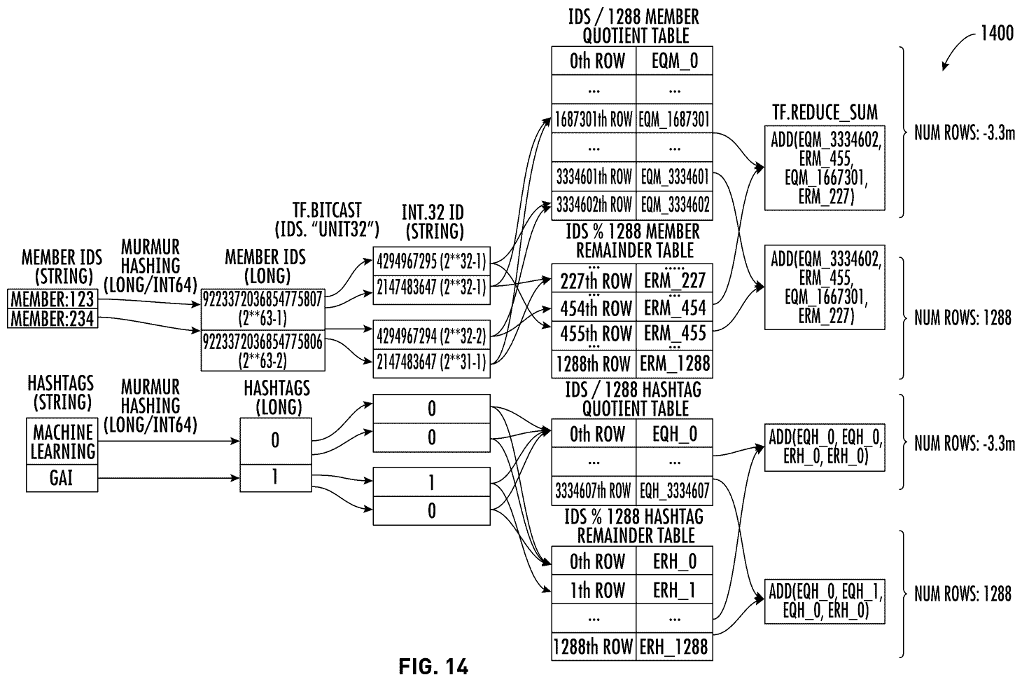

FIG. 14 illustrates a vocabulary hashing model 1400. The vocabulary hashing model 1400 is an example of a non-static vocabulary hashing paradigm model, such as the ML model 816 of the networking system 800.

For model dictionary compression, a traditional approach to mapping high-dimensional sparse categorical features to an embedding space involves two steps. First, it converts string-based ID features to integers using a static hashtable. Next, it utilizes a memory-efficient Minimal Perfect Hashing Function (MPHF) to reduce in-memory size. These integer IDs serve as indices for accessing rows in the embedding matrix, with cardinality matching that of the static hashtable or unique IDs in the training data, capped at a maximum limit. The static hashtable contributes for about 30% of memory usage, which can become inefficient as vocabulary space grow and the vocabulary-to-model size ratio increases. Continuous training further complicates matters, as it demands incremental vocabulary updates to accommodate new data.

As depicted in FIG. 14, the vocabulary hashing model 1400 implements a Quantization and Regularization (QR) hashing model that offers a solution by decomposing large matrices into smaller ones using quotient and remainder techniques while preserving embedding uniqueness across IDs. For instance, a vocabulary of 4 billion with a 1000× compression ratio in a QR strategy results in an embedding matrix of approximately 4 million rows-roughly 4 million from the quotient matrix and around 1800 from the remainder matrix, compared to the traditional 4 billion rows in embedding lookup. This approach has demonstrated comparable performance in offline and online metrics in Feed/Ads. In some cases, sum aggregation works the best, while multiplication aggregation suffers from convergence issues due to numerical precision, when embeddings are initialized close to 0. QR hashing's compatibility with extensive vocabulary opens doors to employing a collision-resistant hashing function like MurmurHash, potentially eliminating vocabulary maintenance. It also generates embedding vectors for every training item ID, resolving the Out-of-Vocabulary (OOV) problem and can potentially capture more diverse signals from the data.

More particularly, the vocabulary hashing model 1400 depicted in FIG. 14 presents an example diagram of non-static vocabulary compression using QR and Murmur hashing. A member ID A in string format like “member: 1234” is mapped with a collision resistant stateless hashing method (e.g., Murmur hashing) to a space of int64 or int32. The larger space will result in a lower collision rate. In one case, int64 is used, and then bitcast is used to convert this int64 to two numbers in int32 space (0-2³²-1), Band C which will look from independent sets of QR tables.

Embedding tables, often exceeding 90% of a large-scale deep ranking model's size, pose challenges with increasing feature, entity, and embedding dimension sizes. These components can reach trillions of parameters, causing storage and inference bottlenecks due to high memory usage [9] and intensive lookup operations. To tackle this, embodiments implement embedding table quantization, a model dictionary compression method that reduces embedding precision and overall model size. For example, using an embedding table of 10 million rows by 128 with fp32 elements, 8-bit row-wise min-max quantization can reduce the table size by over 70%. Research has shown that 8-bit post-training quantization maintains performance and inference speed without extra training costs or calibration data requirements, unlike training-aware quantization. To ensure quick model delivery, engineer flexibility, and smooth model development and deployment, embodiments implement post-training quantization, specifically employing middle-max row-wise embedding-table quantization. Unlike min-max row-wise quantization which saves the minimum value and the quantization bin-scale value of each embedding row, middle-max quantization saves the middle values of Equation (6):

$${X}_{i , :}^{middle} = \frac{{X}_{i , :}^{max} * {2}^{bits - 1} + {X}_{i , :}^{min} * ( {2}^{bits - 1} - 1 )}{{2}^{bits} - 1} , \qquad Equation ( 6 )$$

where Xᵢ^{min}: and Xᵢ^{max}: indicate the minimum and maximum value of the i-th row of an embedding table X. The quantization and dequantization steps are described in Equation (7) and Equation (8):

$${x}_{i , :}^{int} = \text{?} round ( \frac{{X}_{i , :} - {X}_{i , :}^{middle}}{{X}_{i , :}^{scale}} ) \text{?} \qquad Equation ( 7 )$$

$$Equation ( 8 )$$

$${X}_{i , :}^{dequant} \text{?} = {X}_{i , :}^{middle} + {X}_{i , :}^{int} * {X}_{i , :}^{scale} , \text{?} where {X}_{i , :}^{scale} = \frac{\text{?} {X}_{i , :}^{max} - {X}_{i , :}^{min}}{\text{?} {2}^{bits} - 1 \text{?}} \text{?} .$$

$$\text{?} \text{indicates text missing or illegible when filed}$$

Embodiments utilize middle-max quantization for at least two reasons: (1) embedding values typically follow a normal distribution, with more values concentrated in the middle of the quantization range, preserving these middle values reduces quantization errors for high-density values, potentially enhancing generalization performance; and (2) the range of Xᵢ^{int}: values falls within [−128, 127], making integer casting operations from float to int8 reversible and avoiding 2's complement conversion issues, e.g., cast(cast(x, int8), int32) may not be equal to x due to the 2's complement conversion if xϵ[0, 255]. Experimental results show that 8-bit quantization generally achieves performance parity with full precision, maintaining reasonable serving latency even in CPU serving environments with native TF operations. In ads CTR prediction, there was observed a +0.9% CTR relative improvement in online testing, which was attributed to quantization smoothing decision boundaries, improving generalization on unseen data, and enhancing robustness against outliers and adversaries.

During development of large ranking models embodiments optimized training time via set of techniques including four-dimensional (4D) Model Parallelism, Avro Tensor Dataset Loader, offloading last-mile transformation to async stage and prefetching data to a graphics processing unit (GPU) with significant improvements to training speed, as shown in Table 2.

TABLE 2
Training Performance Relative Improvements

| Optimization Applied | e2e Training Time Reduction |
|---|---|
| 4D Model Paralleilism | 71% |
| Avro Tensor Dataset Loader | 50% |
| Offload last-mile transformation | 20% |
| Prefetch dataset to GPU | 15% |

For 4D model parallelism, embodiments utilize Horovod to scale out synchronous training with multiple GPUs. During benchmarking, performance bottlenecks were observed during gradient synchronization of the large embedding tables. Embodiments implement 4D model parallelism in TF to distribute the embedding table into different processes. Each worker process will have one specific part of the embedding table shared among all the workers. This reduces a gradient synchronization time by exchanging input features via all-to-all (to share the features related to the embedding lookup to specific workers), which has a lower communication cost compared to exchanging gradients for large embedding tables. From benchmarks, model parallelism reduced training time from 70 hours to 20 hours.

Embodiments also implement a TF Avro Tensor Dataset Loader and reader that is up to 160× faster than the existing Avro dataset reader according to benchmarks. Major optimizations include removing unnecessary type checks, fusing input/output (I/O) operations (e.g., parsing, batching, shuffling), and thread auto-balancing and tuning. With a dataset loader, embodiments were able to resolve the I/O bottlenecks for training jobs, which is common for large ranking model training. The end-to-end (e2e) training time was reduced by 50% according to benchmark results, as shown in Table 2 above.

Further, some embodiments offload last-mile transformation to asynchronous data pipeline. Some last-mile in-model transformation that happens inside the training loop (e.g., filling empty rows, conversion to Dense, etc.) were observed. Instead of running the transformation plus training synchronously in the training loop, embodiments move the non-training related transformation to a transformation model, and the data transformation happens in the background I/O threads asynchronously with the training step. After training is finished, embodiments stitch the two models together into a final model for serving. The e2e training time was reduced by 20% according to benchmark results, as shown in Table 2 above.

Some embodiments prefetch a dataset to a GPU. During the training profiling, it was observed that CPU to GPU memory copies happen during the beginning of a training step. The memory copy overhead became significant once the batch size was increased to larger values (e.g., taking up to 15% of the training time). Embodiments utilize a customized TF dataset pipeline and Keras Input Layer to prefetch the dataset to GPU in parallel before the next training step begins.

Offline ablation experiments and A/B tests across various surfaces were conducted offline, including Feed Ranking, Ads CTR prediction, and Job recommendations. In Feed Ranking, offline replay metrics are relied upon, which have shown a correlation with production online A/B test results. Meanwhile, for Ads CTR and Job recommendations, it was found that offline AUC measurement aligns well with online experiment outcomes.

Incremental training on both Feed ranking models and Ads CTR models was tested. The experiment configuration is set in Table 3.

TABLE 3
Incremental Experiments Settings

| Experiments | Feed Ranking | Ads CTR |
|---|---|---|
| Cold Start Data Range | 21 days | 14 days |
| Incremental Data Range | 1 day | 0.5 day |
| Incremental Iterations | 6 | 4 |

Testing started with a cold start model, followed by a number of incremental training iterations (i.e., 6 for Feed ranking models and 4 for Ads CTR models). For each incrementally trained model, it was evaluated on a fixed test dataset and average the metrics. The baseline is the evaluation metric on the same fixed test dataset using the cold start model. Table 4 and Table 5 summarize the metrics improvements and training time improvements for both Feed ranking models and Ads CTR models, after tuning the cold weight and 1. For both models, incremental training boosted metrics with significant training time reduction.

TABLE 4
Feed Ranking Model Results Summary

| | Contributions | Training Time |
|---|---|---|
| Cold Start | — | — |
| Incremental Training | +1.02% | −96% |

TABLE 5
Ads CTR Model Results Summary

| | Test AUC | Training Time |
|---|---|---|
| Cold Start | — | — |
| Incremental Training | +0.18% | −96% |

To assess and compare Feed ranking models offline, embodiments employ a “replay” metric that estimates the model's online contribution rate (e.g., likes, comments, re-posts). For evaluation, a small portion of Feed sessions are ranked using a pseudo-random ranking model, which uses the current production model to rank all items but randomizes the order of the top N items uniformly. After training a new experimental model, the same sessions are ranked offline with it. When a matched impression appears at the top position (“matched imp @ 1,” meaning both models ranked the same item at Feed position 1) and the member served the randomized model contributes to that item, a contribution reward is assigned to the experimental model in Equation (9):

$$Equation ( 9 )$$

$$contribution rate = \frac{\# of matched imps @ 1 with contribution}{\# of matched imps @ 1}$$

This methodology allows unbiased offline comparison of experimental models. Embodiments use offline replay to assess Feed Ranking models, referred to as “contributions” in Table 6.

TABLE 6
Ablation study of model architecture components in Feed
Ranking on the relative off-policy measurement.

| Model | Contributions |
|---|---|
| Baseline | — |
| +30 dimensional ID embeddings (IDs) | +1.89% |
| +Isotonic calibration layer | +1.08% |
| +Large MLP (LMLP) | +1.23% |
| +Dense Gating (DG) | +1.00% |
| +Multi-task (MTL) Grouping | +0.75% |
| +Low-rank DCNv2 (LDCNv2) | +1.26% |
| +TransAct | +1.66% |
| +Residual DCN (RDCN) | +2.15% |
| +LDCNv2 + LMLP + TransAct | +3.45% |
| +RDCN + LMLP + TransAct | +3.62% |
| +Sparsly Gated MMoE | +4.14% |

Table 6 illustrates the impact of various production modeling techniques on offline replay metrics, including Isotonic calibration layer, low-rank DCN-V2, Residual DCN, Dense Gating, Large MLP layer, Sparse Features, MTL enhancements, TransAct, and Sparsely Gated MMOE. These techniques, listed in Table 6, are presented in chronological order of development, highlighting incremental improvements. Embodiments deploy these techniques to production, and through online A/B testing, a 0.5% relative increase in the number of member sessions visiting were observed. In search ranking models, 40 categorical features are embedded through 5 shared embedding matrices for title, skill, company, industry, and seniority. The model predicts probability of P (job application) and P (job click). Embodiments adopt embedding dictionary compression as previously described with a 5× reduction of number of model parameters, and the evaluation does not show any performance loss compared to using a vanilla ID embedding lookup table. Improvements were not observed by using Dense Gating in search models with extensive tuning of models. These entity ID embeddings are shared by search recommendations, and then a task-specific 2-layer DCN is added on top to explicitly capture the feature interactions. Overall a significant offline AUC lift of +1.63% for Job Search and 2.10% for JYMBII was observed. For reproducibility purposes, a model architecture and ablation study of different components of JYMBII and Job Search model are provided below.

The ranking models with higher AUC shown above also transferred to significant metrics lift in the online A/B testing. Percent Chargeable Views is the fraction of clicks among all clicks on promoted jobs. Qualified Application is the total count of all qualified job applications.

TABLE 7
Online experiment relative metrics improvements
of JS and JYMBII ranking

| Online Metrics | Job Search | JYMBII |
|---|---|---|
| Percent Chargeable Views | +1.70% | +4.16% |
| Qualified Application | +0.89% | +0.87% |

Embodiments utilize a baseline model of a multilayer perceptron model that is derived from its predecessor Generalized Deep Mixed (GDMix) model with proper hyper-parameter tuning. Features fall into five categories: contextual, advertisement, member, advertiser, ad-member interaction. The baseline model does not have ID features. Table 5 shows relative improvements of each of the techniques including ID embeddings, Quantization, Lowrank DCN-V2, TransAct and Isotonic calibration layer. Techniques mentioned in Table 5 are ordered in timeline of development. We have deployed techniques to production and observed 4.3% CTR relative improvement in online A/B tests.

TABLE 8
Ablation study of different Ads CTR model
architec-ture variants on the test AUC.

| Model | AUC |
|---|---|
| Baseline | — |
| ID embeddings (IDs) | +1.27% |
| IDs + Quantization 8-bit | +1.28% |
| IDs + DCNv2 | +1.45% |
| IDs + low-rank DCNv2 | +1.37% |
| IDs + isotonic layer | +1.39% |
| IDs + low-rank DCNv2 + isotonic layer | (O/E ratio + 1.84%) |
| | +1.47% |
| IDs + TransAct | +2.20% |

Over the time of development deployment lessons of the models described herein were used to improve the deployment strategy. Some examples are provided below.

Some embodiments scale up Feed training data generation. At the core of the Feed training data generation is a join between post labels and features. The labels dataset comprises impressed posts from all sessions. The features dataset exists on a session level. Here, each row contains session-level features and all served posts with their post-level features. To combine these, embodiments explode the features dataset to be on a post-level and join with the labels dataset. However, as Feed scaled up from using 13% of sessions for training to using 1100% of sessions, this join caused long delay. To optimize the pipeline embodiments implement two key changes in this pipeline. These changes reduce the runtime by 80% and stabilize the job. Firstly, it was recognized that not all served posts are impressed. This means the join with the labels dataset drastically reduces the number of rows. Furthermore, exploding the features dataset repeats session-level features for every post. Embodiments therefore changed the pipeline to explode only the post features and keys, join with the labels, and add the session-level features in a second join. Despite this resulting in two joins, each join was now smaller and resulted in an overall shuffle write size reduction of 60%. Secondly, embodiments tune the Spark compression, which resulted in an additional 25% shuffle write size reduction. These changes allowed embodiments to move forward with 100% of sessions for training.

With respect to model convergence, adding DCN-V2 came with challenges for model training. For example, during initial training experiments with DCN-V2 it was observed that a large number of runs were diverging. To improve model training stability embodiments increase learning rate warm-up from 5% to 50% of training steps. This resolves the instability issues and also significantly boosted the offline relevance gains brought about by adding DCN-V2. Embodiments also applied batch normalization to the numeric input features. Finally, it was found that at a number of training steps were under-fitting. This became clear when it was observed that increasing the training steps significantly improved offline relevance metrics. However, increasing the number of training steps was not an option for production due to the decrease in experimentation velocity. As a solution, embodiments found that given the increased warm-up steps, training was stable enough for higher learning rates. Increasing the learning rate three-fold allowed embodiments to almost completely bridge any relevance metric gaps found compared to longer training.

Optimization needs varied across different models. While Adam was generally effective, models with numerous sparse features required AdaGrad, which significantly impacted their performance. Furthermore, strategies like learning rate warm-up and gradient clipping were especially beneficial for larger batch sizes to enhance model generalization. Embodiments consistently implement learning rate warm-up for larger batches, increasing the learning rate over a doubled fraction of steps whenever batch size doubled, but not exceeding 60% of the total training steps. By doing so, embodiments improve generalization across various settings and narrowed the gap in generalization at larger batch sizes.

In this application, embodiments implement the LiRank framework providing significant improvements over SOTA models. Embodiments implement various modeling architectures and their combination to create a high-performance model for delivering relevant user recommendations. LiRank has been deployed in multiple domain applications at LinkedIn, resulting in significant production impact.

The sparse ID Feed Ranking embedding features comprises: (1) Viewer Historical Actor IDs, which were frequently interacted in the past by the viewer, analogous to Viewer-Actor Affinity; (2) Actor Id, who is the creator of the post; (3) Actor Historical Actor Ids, which are creators who frequently interacted in the past by the creator of the post; (4) Viewer Hashtag Ids, which were frequently interacted in the past by the viewer; (5) Actor Hashtag Ids, which were frequently interacted in the past by the actor of the post; and (6) Post Hashtag Ids (e.g. #machinelearning).

Unlimited dictionary sparse ID features were used as previously described. It was empirically found that 30 dimensions are optimal for the ID embeddings. The sparse ID embedding features mentioned above are concatenated with all other dense features and then passed through a multi-layer perception (MLP) consisting of 4 connected layers, each with output dimension of 100.

The IDs in large personalizing models are often strings and sparse numerical values. To map the unique sparse IDs to embedding index without any collision, then a lookup table is needed which is typically implemented as a hash table (e.g., std::unordered_map in TF). These hash tables grow into several gigabytes (GBs) and often take up even more memory than the model parameters. To resolve the serving memory issue, embodiments implement a minimal perfect hashing function (MPHF) in TF Custom Ops, which reduces the memory usage of vocab lookup by 100x. However, embodiments face a 3x slowdown in training time when the hashing is performed on the fly as part of training. It was observed that the maximum value of IDs could be represented using int32. To compress the vocabulary without degrading the training time, embodiments first hash the string ID into int32, and then use a map implementation to store the vocabulary. Embodiments use a Spark job to perform the hashing and thus are able to avoid training time degradation. The hashing from string to int32 provides a 93% heap size reduction. Significant degradation in engagement metrics because of hashing were not observed.

The subsequent effort mentioned above successfully eliminated the static hash table from the model artifact by employing collision-resistant hashing and QR hashing techniques. This removal was achieved without any performance drop, considering both runtime and relevance perspectives.

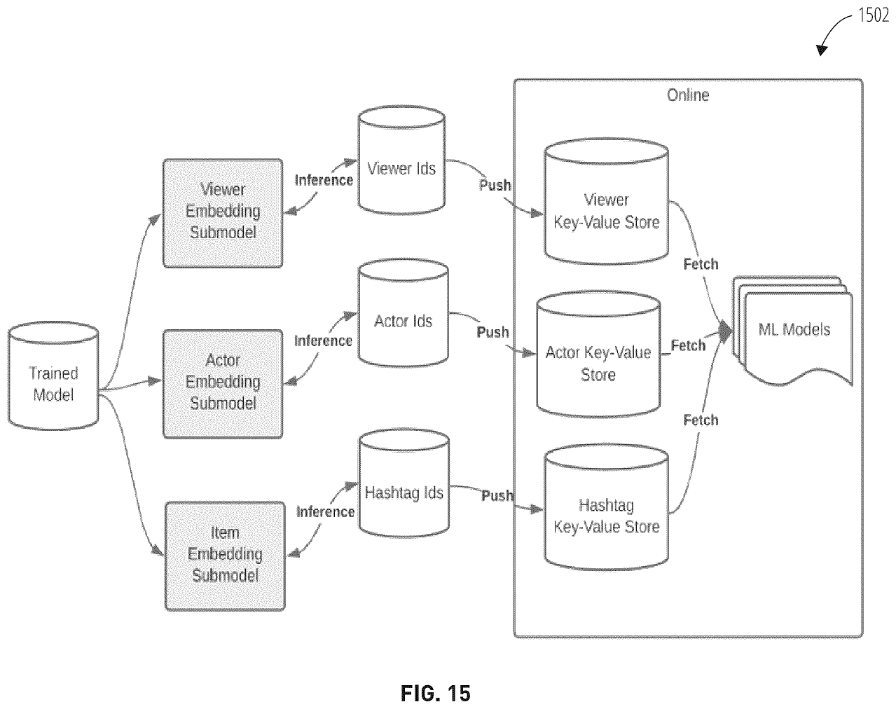

FIG. 15 illustrates a system 1502 of an external serving strategy. The system 1502 is an example of a system suitable for use with an AI system, such as the networking system 800.

The system 1502 performs external serving of ID embeddings versus in-memory serving. One of the challenges was constrained memory on serving hosts, hindering the deployment of multiple models. To expedite the delivery embodiments initially adopted external serving of model parameters in a key-value store, partitioning model graphs and precomputing embeddings for online retrieval. Potential issues include: (1) iteration flexibility for ML engineers, who depended on the consumption of ID embeddings; and (2) staleness of pre-computed features pushed daily to the online store. To handle billion-parameter models concurrently from memory, embodiments utilize upgraded hardware and optimized memory consumption by garbage collection tuning, and crafting data representations for model parameters through quantization and ID vocabulary transformation optimized memory usage. When transitioned to in-memory serving, it yielded enhanced engagement metrics and empowered modelers with reduced operational costs.

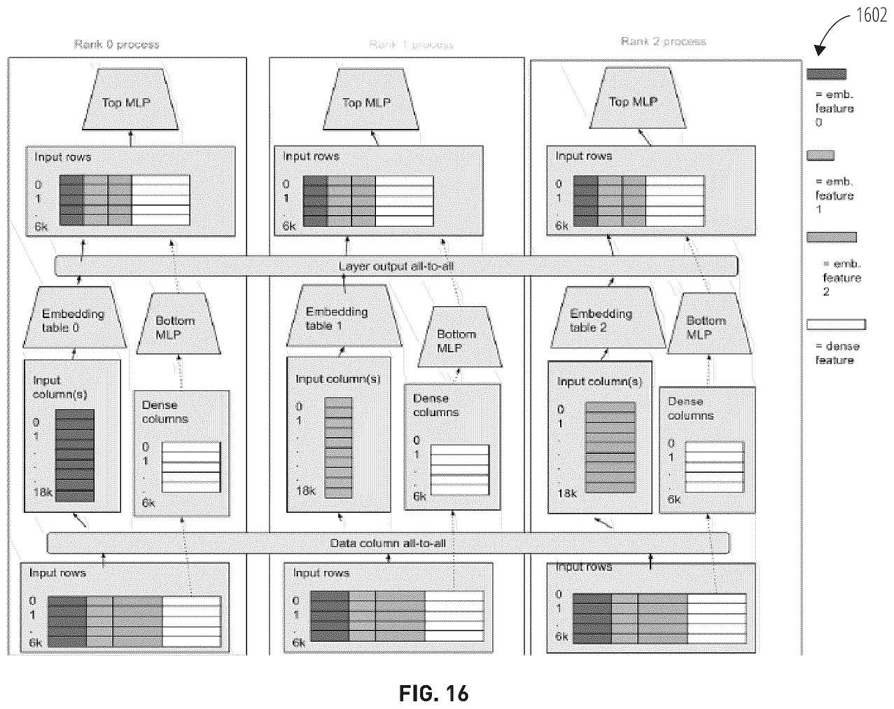

FIG. 16 illustrates an example of a model architecture 1602 for the ML model 816 of the networking system 800. The model architecture 1602 is an example of model parallelism for large embedding tables. The model architecture 1602 shows an example for three embedding tables. Each embedding table is placed on a GPU, and each GPU's input batch is all-to-all′ed so that every GPU receives the input columns belonging to its embedding table. Each GPU does its local embedding lookup, and the lookups are all-to-all′ed to return the output to the GPU that the input column came from. Other layers with fewer parameters (such as MLP layers) are still processed in a data parallel.

Table 9 presents a study on how history length influences the impact of the Feed Ranking model. An increasing trend of engagement was observed to increase as longer history of user engagement were used over sequence architecture as previously described.

TABLE 9
Offline relevance metrics for the feed from the addition of
member history modeling with different sequence lengths.

| Model | Contributions |
|---|---|
| Baseline | — |
| +Member history length 25 | +1.31% |
| +Member history length 50 | +1.57% |
| +Member history length 100 | +1.66% |

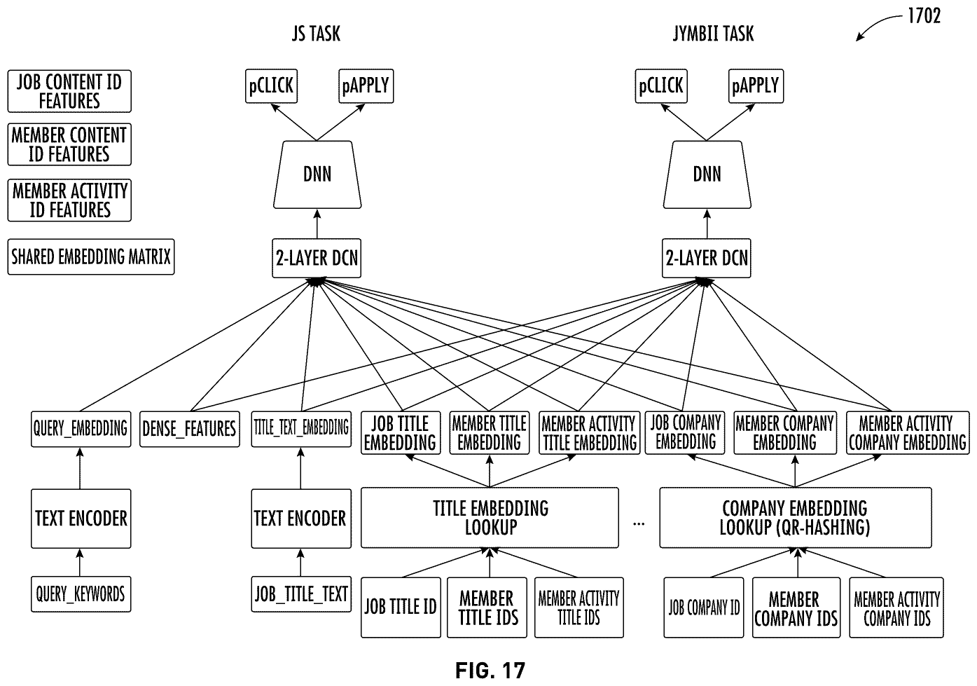

FIG. 17 illustrates an example of a model architecture 1702 for an ML model 816 of the networking system 800. The model architecture 1702 is an example of a Jobs Recommendations Ranking Model Architecture. As shown in FIG. 17, the jobs recommendation ranking model employs a multi-tasks training framework that unifies Job Search (JS) and Jobs You Might be Interested In (JYMBII) tasks in a single model. The ID embedding matrices are added into the bottom layer to be shared by the two tasks, followed by a task-specific 2-layer DCN-V2 to learn feature interactions. Various experiments were conducted to apply different architectures of feature interactions, and the 2-layer DCN performs best among all. The results on the JYMBII task are demonstrated in the Table 10.

TABLE 10
Ablation study of different jobs recommendation model
architecture variants on the JYMBII test AUC.

| Model | AUC |
|---|---|
| Baseline | — |
| IDs + Wide&Deep [5] | +0.37% |
| IDs + Wide&Deep + Dense Gating (§3.5) | +0.33% |
| IDs + DeepFM [12] | +0.39% |
| IDs + FinalMLP [20] | +2.17% |
| IDs + DCNv2 [35] | +2.23% |
| IDs + DCNv2 + QR hashing (§3.12) | +2.23% |

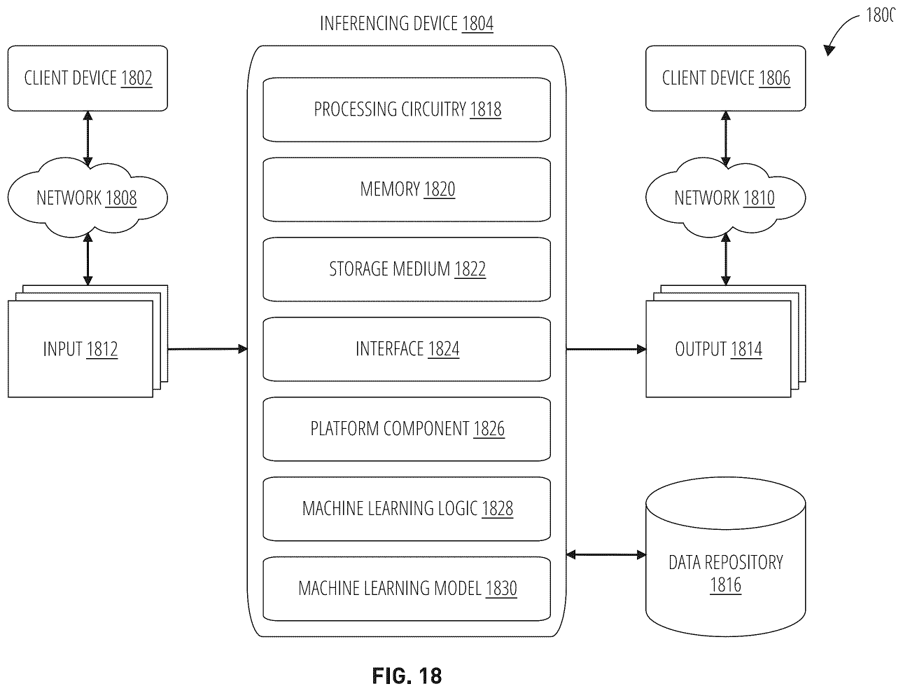

FIG. 18 illustrates an embodiment of a system 1800. The system 1800 is suitable for implementing one or more embodiments as described herein. In one embodiment, for example, the system 1800 is an AI/ML system suitable for implementing models described with reference to FIG. 11 to FIG. 17.

The system 1800 comprises a set of M devices, where M is any positive integer. FIG. 18 depicts three devices (M=3), including a client device 1802, an inferencing device 1804, and a client device 1806. The inferencing device 1804 communicates information with the client device 1802 and the client device 1806 over a network 1808 and a network 1810, respectively. The information may include input 1812 from the client device 1802 and output 1814 to the client device 1806, or vice-versa. In one alternative, the input 1812 and the output 1814 are communicated between the same client device 1802 or client device 1806. In another alternative, the input 1812 and the output 1814 are stored in a data repository 1816. In yet another alternative, the input 1812 and the output 1814 are communicated via a platform component 1826 of the inferencing device 1804, such as an input/output (I/O) device (e.g., a touchscreen, a microphone, a speaker, etc.).

As depicted in FIG. 18, the inferencing device 1804 includes processing circuitry 1818, a memory 1820, a storage medium 1822, an interface 1824, a platform component 1826, ML logic 1828, and an ML model 1830. In some implementations, the inferencing device 1804 includes other components or devices as well. Examples for software elements and hardware elements of the inferencing device 1804 are described in more detail with reference to a computing architecture 2300 as depicted in FIG. 23. Embodiments are not limited to these examples.

The inferencing device 1804 is generally arranged to receive an input 1812, process the input 1812 via one or more AI/ML techniques, and send an output 1814. The inferencing device 1804 receives the input 1812 from the client device 1802 via the network 1808, the client device 1806 via the network 1810, the platform component 1826 (e.g., a touchscreen as a text command or microphone as a voice command), the memory 1820, the storage medium 1822 or the data repository 1816. The inferencing device 1804 sends the output 1814 to the client device 1802 via the network 1808, the client device 1806 via the network 1810, the platform component 1826 (e.g., a touchscreen to present text, graphic or video information or speaker to reproduce audio information), the memory 1820, the storage medium 1822 or the data repository 1816. Examples for the software elements and hardware elements of the network 1808 and the network 1810 are described in more detail with reference to a communications architecture 2400 as depicted in FIG. 24. Embodiments are not limited to these examples.

The inferencing device 1804 includes ML logic 1828 and an ML model 1830 to implement various AI/ML techniques for various AI/ML tasks. The ML logic 1828 receives the input 1812, and processes the input 1812 using the ML model 1830. The ML model 1830 performs inferencing operations to generate an inference for a specific task from the input 1812. In some cases, the inference is part of the output 1814. The output 1814 is used by the client device 1802, the inferencing device 1804, or the client device 1806 to perform subsequent actions in response to the output 1814.

In various embodiments, the ML model 1830 is a trained ML model 1830 using a set of training operations. An example of training operations to train the ML model 1830 is described with reference to FIG. 19.

FIG. 19 illustrates an apparatus 1900. The apparatus 1900 depicts a training device 1914 suitable to generate a trained ML model 1830 for the inferencing device 1804 of the system 1800. As depicted in FIG. 19, the training device 1914 includes a processing circuitry 1916 and a set of ML components 1910 to support various AI/ML techniques, such as a data collector 1902, a model trainer 1904, a model evaluator 1906 and a model inferencer 1908.

In general, the data collector 1902 collects data 1912 from one or more data sources to use as training data for the ML model 1830. The data collector 1902 collects different types of data 1912, such as text information, audio information, image information, video information, graphic information, and so forth. The model trainer 1904 receives as input the collected data and uses a portion of the collected data as test data for an AI/ML algorithm to train the ML model 1830. The model evaluator 1906 evaluates and improves the trained ML model 1830 using a portion of the collected data as test data to test the ML model 1830. The model evaluator 1906 also uses feedback information from the deployed ML model 1830. The model inferencer 1908 implements the trained ML model 1830 to receive as input new unseen data, generate one or more inferences on the new data, and output a result such as an alert, a recommendation or other post-solution activity.

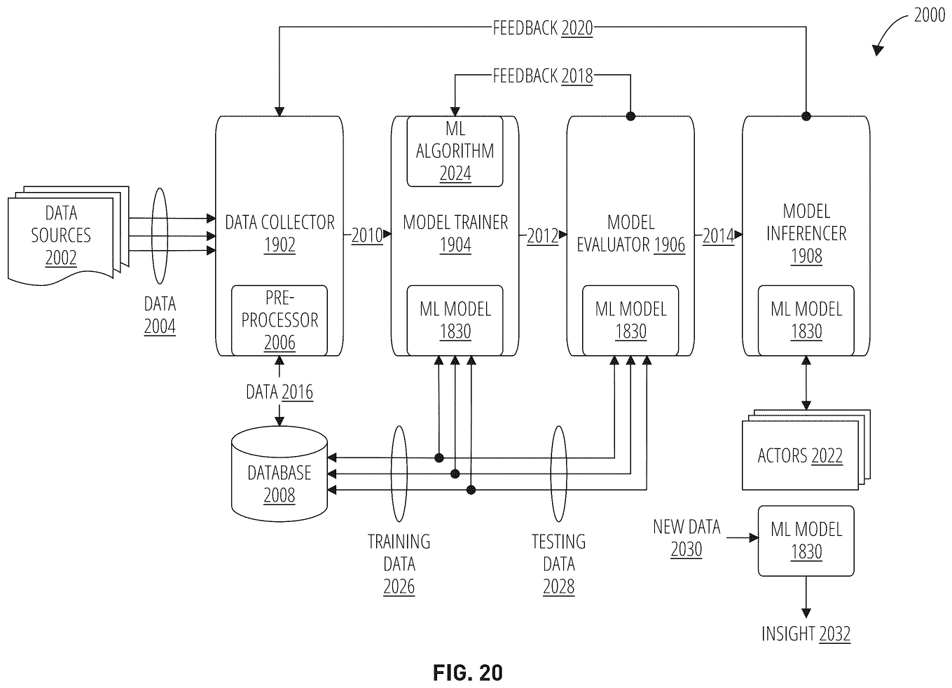

An exemplary AI/ML architecture for the ML components 1910 is described in more detail with reference to FIG. 20.

FIG. 20 illustrates an artificial intelligence architecture 2000 suitable for use by the training device 1914 to generate the ML model 1830 for deployment by the inferencing device 1804. The artificial intelligence architecture 2000 is an example of a system suitable for implementing various AI techniques and/or ML techniques to perform various inferencing tasks on behalf of the various devices of the system 1800.

AI is a science and technology based on principles of cognitive science, computer science and other related disciplines, which deals with the creation of intelligent machines that work and react like humans. AI is used to develop systems that can perform tasks that require human intelligence such as recognizing speech, vision and making decisions. AI can be seen as the ability for a machine or computer to think and learn, rather than just following instructions. ML is a subset of AI that uses algorithms to enable machines to learn from existing data and generate insights or predictions from that data. ML algorithms are used to optimize machine performance in various tasks such as classifying, clustering and forecasting. ML algorithms are used to create ML models that can accurately predict outcomes.

In general, the artificial intelligence architecture 2000 includes various machine or computer components (e.g., circuit, processor circuit, memory, network interfaces, compute platforms, input/output (I/O) devices, etc.) for an AI/ML system that are designed to work together to create a pipeline that can take in raw data, process it, train an ML model 1830, evaluate performance of the trained ML model 1830, and deploy the tested ML model 1830 as the trained ML model 1830 in a production environment, and continuously monitor and maintain it.

The ML model 1830 is a mathematical construct used to predict outcomes based on a set of input data. The ML model 1830 is trained using large volumes of training data 2026, and it can recognize patterns and trends in the training data 2026 to make accurate predictions. The ML model 1830 is derived from an ML algorithm 2024 (e.g., a neural network, decision tree, support vector machine, etc.). A data set is fed into the ML algorithm 2024 which trains an ML model 1830 to “learn” a function that produces mappings between a set of inputs and a set of outputs with a reasonably high accuracy. Given a sufficiently large enough set of inputs and outputs, the ML algorithm 2024 finds the function for a given task. This function may even be able to produce the correct output for input that it has not seen during training. A data scientist prepares the mappings, selects and tunes the ML algorithm 2024, and evaluates the resulting model performance. Once the ML logic 1828 is sufficiently accurate on test data, it can be deployed for production use.

The ML algorithm 2024 may comprise any ML algorithm suitable for a given AI task. Examples of ML algorithms may include supervised algorithms, unsupervised algorithms, or semi-supervised algorithms.

A supervised algorithm is a type of machine learning algorithm that uses labeled data to train a machine learning model. In supervised learning, the machine learning algorithm is given a set of input data and corresponding output data, which are used to train the model to make predictions or classifications. The input data is also known as the features, and the output data is known as the target or label. The goal of a supervised algorithm is to learn the relationship between the input features and the target labels, so that it can make accurate predictions or classifications for new, unseen data. Examples of supervised learning algorithms include: (1) linear regression which is a regression algorithm used to predict continuous numeric values, such as stock prices or temperature; (2) logistic regression which is a classification algorithm used to predict binary outcomes, such as whether a customer will purchase or not purchase a product; (3) decision tree which is a classification algorithm used to predict categorical outcomes by creating a decision tree based on the input features; or (4) random forest which is an ensemble algorithm that combines multiple decision trees to make more accurate predictions.

An unsupervised algorithm is a type of machine learning algorithm that is used to find patterns and relationships in a dataset without the need for labeled data. Unlike supervised learning, where the algorithm is provided with labeled training data and learns to make predictions based on that data, unsupervised learning works with unlabeled data and seeks to identify underlying structures or patterns. Unsupervised learning algorithms use a variety of techniques to discover patterns in the data, such as clustering, anomaly detection, and dimensionality reduction. Clustering algorithms group similar data points together, while anomaly detection algorithms identify unusual or unexpected data points. Dimensionality reduction algorithms are used to reduce the number of features in a dataset, making it easier to analyze and visualize. Unsupervised learning has many applications, such as in data mining, pattern recognition, and recommendation systems. It is particularly useful for tasks where labeled data is scarce or difficult to obtain, and where the goal is to gain insights and understanding from the data itself rather than to make predictions based on it.

Semi-supervised learning is a type of machine learning algorithm that combines both labeled and unlabeled data to improve the accuracy of predictions or classifications. In this approach, the algorithm is trained on a small amount of labeled data and a much larger amount of unlabeled data. The main idea behind semi-supervised learning is that labeled data is often scarce and expensive to obtain, whereas unlabeled data is abundant and easy to collect. By leveraging both types of data, semi-supervised learning can achieve higher accuracy and better generalization than either supervised or unsupervised learning alone. In semi-supervised learning, the algorithm first uses the labeled data to learn the underlying structure of the problem. It then uses this knowledge to identify patterns and relationships in the unlabeled data, and to make predictions or classifications based on these patterns. Semi-supervised learning has many applications, such as in speech recognition, natural language processing, and computer vision. It is particularly useful for tasks where labeled data is expensive or time-consuming to obtain, and where the goal is to improve the accuracy of predictions or classifications by leveraging large amounts of unlabeled data.

The ML algorithm 2024 of the artificial intelligence architecture 2000 is implemented using various types of ML algorithms including supervised algorithms, unsupervised algorithms, semi-supervised algorithms, or a combination thereof. A few examples of ML algorithms include support vector machine (SVM), random forests, naive Bayes, K-means clustering, neural networks, and so forth. A SVM is an algorithm that can be used for both classification and regression problems. It works by finding an optimal hyperplane that maximizes the margin between the two classes. Random forests is a type of decision tree algorithm that is used to make predictions based on a set of randomly selected features. Naive Bayes is a probabilistic classifier that makes predictions based on the probability of certain events occurring. K-Means Clustering is an unsupervised learning algorithm that groups data points into clusters. Neural networks is a type of machine learning algorithm that is designed to mimic the behavior of neurons in the human brain. Other examples of ML algorithms include a support vector machine (SVM) algorithm, a random forest algorithm, a naive Bayes algorithm, a K-means clustering algorithm, a neural network algorithm, an artificial neural network (ANN) algorithm, a convolutional neural network (CNN) algorithm, a recurrent neural network (RNN) algorithm, a long short-term memory (LSTM) algorithm, a deep learning algorithm, a decision tree learning algorithm, a regression analysis algorithm, a Bayesian network algorithm, a genetic algorithm, a federated learning algorithm, a distributed artificial intelligence algorithm, and so forth. Embodiments are not limited in this context.

As depicted in FIG. 20, the artificial intelligence architecture 2000 includes a set of data sources 2002 to source data 2004 for the artificial intelligence architecture 2000. Data sources 2002 may comprise any device capable generating, processing, storing or managing data 2004 suitable for a ML system. Examples of data sources 2002 include without limitation databases, web scraping, sensors and Internet of Things (IoT) devices, image and video cameras, audio devices, text generators, publicly available databases, private databases, and many other data sources 2002. The data sources 2002 may be remote from the artificial intelligence architecture 2000 and accessed via a network, local to the artificial intelligence architecture 2000 an accessed via a network interface, or may be a combination of local and remote data sources 2002.

The data sources 2002 source difference types of data 2004. By way of example and not limitation, the data 2004 includes structured data from relational databases, such as customer profiles, transaction histories, or product inventories. The data 2004 includes unstructured data from websites such as customer reviews, news articles, social media posts, or product specifications. The data 2004 includes data from temperature sensors, motion detectors, and smart home appliances. The data 2004 includes image data from medical images, security footage, or satellite images. The data 2004 includes audio data from speech recognition, music recognition, or call centers. The data 2004 includes text data from emails, chat logs, customer feedback, news articles or social media posts. The data 2004 includes publicly available datasets such as those from government agencies, academic institutions, or research organizations. These are just a few examples of the many sources of data that can be used for ML systems. It is important to note that the quality and quantity of the data is critical for the success of a machine learning project.

The data 2004 is typically in different formats such as structured, unstructured or semi-structured data. Structured data refers to data that is organized in a specific format or schema, such as tables or spreadsheets. Structured data has a well-defined set of rules that dictate how the data should be organized and represented, including the data types and relationships between data elements. Unstructured data refers to any data that does not have a predefined or organized format or schema. Unlike structured data, which is organized in a specific way, unstructured data can take various forms, such as text, images, audio, or video. Unstructured data can come from a variety of sources, including social media, emails, sensor data, and website content. Semi-structured data is a type of data that does not fit neatly into the traditional categories of structured and unstructured data. It has some structure but does not conform to the rigid structure of a traditional relational database. Semi-structured data is characterized by the presence of tags or metadata that provide some structure and context for the data.

The data sources 2002 are communicatively coupled to a data collector 1902. The data collector 1902 gathers relevant data 2004 from the data sources 2002. Once collected, the data collector 1902 may use a pre-processor 2006 to make the data 2004 suitable for analysis. This involves data cleaning, transformation, and feature engineering. Data preprocessing is a critical step in ML as it directly impacts the accuracy and effectiveness of the ML model 1830. The pre-processor 2006 receives the data 2004 as input, processes the data 2004, and outputs pre-processed data 2016 for storage in a database 2008. Examples for the database 2008 includes a hard drive, solid state storage, and/or random access memory (RAM).

The data collector 1902 is communicatively coupled to a model trainer 1904. The model trainer 1904 performs AI/ML model training, validation, and testing which may generate model performance metrics as part of the model testing procedure. The model trainer 1904 receives the pre-processed data 2016 as input 2010 or via the database 2008. The model trainer 1904 implements a suitable ML algorithm 2024 to train an ML model 1830 on a set of training data 2026 from the pre-processed data 2016. The training process involves feeding the pre-processed data 2016 into the ML algorithm 2024 to produce or optimize an ML model 1830. The training process adjusts its parameters until it achieves an initial level of satisfactory performance.

The model trainer 1904 is communicatively coupled to a model evaluator 1906. After an ML model 1830 is trained, the ML model 1830 needs to be evaluated to assess its performance. This is done using various metrics such as accuracy, precision, recall, and F1 score. The model trainer 1904 outputs the ML model 1830, which is received as input 2010 or from the database 2008. The model evaluator 1906 receives the ML model 1830 as input 2012, and it initiates an evaluation process to measure performance of the ML model 1830. The evaluation process includes providing feedback 2018 to the model trainer 1904. The model trainer 1904 re-trains the ML model 1830 to improve performance in an iterative manner.

The model evaluator 1906 is communicatively coupled to a model inferencer 1908. The model inferencer 1908 provides AI/ML model inference output (e.g., inferences, predictions or decisions). Once the ML model 1830 is trained and evaluated, it is deployed in a production environment where it is used to make predictions on new data. The model inferencer 1908 receives the evaluated ML model 1830 as input 2014. The model inferencer 1908 uses the evaluated ML model 1830 to produce insights or predictions on real data, which is deployed as a final production ML model 1830. The inference output of the ML model 1830 is use case specific. The model inferencer 1908 also performs model monitoring and maintenance, which involves continuously monitoring performance of the ML model 1830 in the production environment and making any necessary updates or modifications to maintain its accuracy and effectiveness. The model inferencer 1908 provides feedback 2018 to the data collector 1902 to train or re-train the ML model 1830. The feedback 2018 includes model performance feedback information, which is used for monitoring and improving performance of the ML model 1830.

Some or all of the model inferencer 1908 is implemented by various actors 2022 in the artificial intelligence architecture 2000, including the ML model 1830 of the inferencing device 1804, for example. The actors 2022 use the deployed ML model 1830 on new data to make inferences or predictions for a given task, and output an insight 2032. The actors 2022 implement the model inferencer 1908 locally, or remotely receives outputs from the model inferencer 1908 in a distributed computing manner. The actors 2022 trigger actions directed to other entities or to itself. The actors 2022 provide feedback 2020 to the data collector 1902 via the model inferencer 1908. The feedback 2020 comprise data needed to derive training data, inference data or to monitor the performance of the ML model 1830 and its impact to the network through updating of key performance indicators (KPIs) and performance counters.

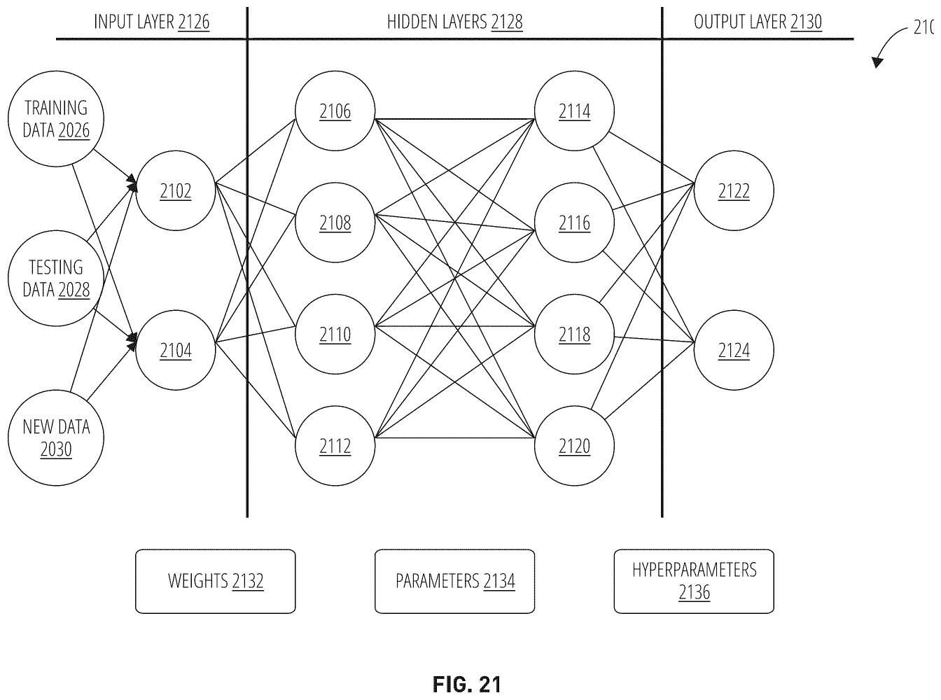

As previously described with reference to FIGS. 1, 2, the systems 1800, 1900 implement some or all of the artificial intelligence architecture 2000 to support various use cases and solutions for various AI/ML tasks. In various embodiments, the training device 1914 of the apparatus 1900 uses the artificial intelligence architecture 2000 to generate and train the ML model 1830 for use by the inferencing device 1804 for the system 1800. In one embodiment, for example, the training device 1914 may train the ML model 1830 as a neural network, as described in more detail with reference to FIG. 21. Other use cases and solutions for AI/ML are possible as well, and embodiments are not limited in this context.

FIG. 21 illustrates an embodiment of an artificial neural network 2100. Neural networks, also known as artificial neural networks (ANNs) or simulated neural networks (SNNs), are a subset of machine learning and are at the core of deep learning algorithms. Their name and structure are inspired by the human brain, mimicking the way that biological neurons signal to one another.

Artificial neural network 2100 comprises multiple node layers, containing an input layer 2126, one or more hidden layers 2128, and an output layer 2130. Each layer comprises one or more nodes, such as nodes 2102 to 2124. As depicted in FIG. 21, for example, the input layer 2126 has nodes 2102, 2104. The artificial neural network 2100 has two hidden layers 2128, with a first hidden layer having nodes 2106, 2108, 2110 and 2112, and a second hidden layer having nodes 2114, 2116, 2118 and 2120. The artificial neural network 2100 has an output layer 2130 with nodes 2122, 2124. Each node 2102 to 2124 comprises a processing element (PE), or artificial neuron, that connects to another and has an associated weight and threshold. If the output of any individual node is above the specified threshold value, that node is activated, sending data to the next layer of the network. Otherwise, no data is passed along to the next layer of the network.

In general, artificial neural network 2100 relies on training data 2026 to learn and improve accuracy over time. However, once the artificial neural network 2100 is fine-tuned for accuracy, and tested on testing data 2028, the artificial neural network 2100 is ready to classify and cluster new data 2030 at a high velocity. Tasks in speech recognition or image recognition can take minutes versus hours when compared to the manual identification by human experts.

Each individual node 2102 to 424 is a linear regression model, composed of input data, weights, a bias (or threshold), and an output. The linear regression model may have a formula similar to Equation (10), as follows:

$$\sum wixi + bias = w 1 x 1 + w 2 x 2 + w 3 x3 + bias \qquad EQUATION ( 10 )$$

$$output = f ( x ) = 1 if \sum w 1 x 1 + b >= 0 ; 0 if \sum w 1 x 1 + b < 0$$

Once an input layer 2126 is determined, a set of weights 2132 are assigned. The weights 2132 help determine the importance of any given variable, with larger ones contributing more significantly to the output compared to other inputs. All inputs are then multiplied by their respective weights and then summed. Afterward, the output is passed through an activation function, which determines the output. If that output exceeds a given threshold, it “fires” (or activates) the node, passing data to the next layer in the network. This results in the output of one node becoming in the input of the next node. The process of passing data from one layer to the next layer defines the artificial neural network 2100 as a feedforward network.

In one embodiment, the artificial neural network 2100 leverages sigmoid neurons, which are distinguished by having values between 0 and 1. Since the artificial neural network 2100 behaves similarly to a decision tree, cascading data from one node to another, having x values between 0 and 1 will reduce the impact of any given change of a single variable on the output of any given node, and subsequently, the output of the artificial neural network 2100.

The artificial neural network 2100 has many practical use cases, like image recognition, speech recognition, text recognition or classification. The artificial neural network 2100 leverages supervised learning, or labeled datasets, to train the algorithm. As the model is trained, its accuracy is measured using a cost (or loss) function. This is also commonly referred to as the mean squared error (MSE). An example of a cost function is shown in Equation (11), as follows:

$$EQUATION ( 11 )$$

$$Cost Function = MSE = \frac{1}{2 m} {\sum }_{i = 1}^{m} ( - {y}_{i} \text{?} \to MIN$$

$$\text{?} \text{indicates text missing or illegible when filed}$$

Where i represents the index of the sample, y-hat is the predicted outcome, y is the actual value, and m is the number of samples.

Ultimately, the goal is to minimize the cost function to ensure correctness of fit for any given observation. As the model adjusts its weights and bias, it uses the cost function and reinforcement learning to reach the point of convergence, or the local minimum. The process in which the algorithm adjusts its weights is through gradient descent, allowing the model to determine the direction to take to reduce errors (or minimize the cost function). With each training example, the parameters 2134 of the model adjust to gradually converge at the minimum.

In one embodiment, the artificial neural network 2100 is feedforward, meaning it flows in one direction only, from input to output. In one embodiment, the artificial neural network 2100 uses backpropagation. Backpropagation is when the artificial neural network 2100 moves in the opposite direction from output to input. Backpropagation allows calculation and attribution of errors associated with each neuron 2102 to 2124, thereby allowing adjustment to fit the parameters 2134 of the ML model 1830 appropriately.

The artificial neural network 2100 is implemented as different neural networks depending on a given task. Neural networks are classified into different types, which are used for different purposes. In one embodiment, the artificial neural network 2100 is implemented as a feedforward neural network, or multi-layer perceptrons (MLPs), comprised of an input layer 2126, hidden layers 2128, and an output layer 2130. While these neural networks are also commonly referred to as MLPs, they are actually comprised of sigmoid neurons, not perceptrons, as most real-world problems are nonlinear. Trained data 2004 usually is fed into these models to train them, and they are the foundation for computer vision, natural language processing, and other neural networks. In one embodiment, the artificial neural network 2100 is implemented as a convolutional neural network (CNN). A CNN is similar to feedforward networks, but usually utilized for image recognition, pattern recognition, and/or computer vision. These networks harness principles from linear algebra, particularly matrix multiplication, to identify patterns within an image. In one embodiment, the artificial neural network 2100 is implemented as a recurrent neural network (RNN). A RNN is identified by feedback loops. The RNN learning algorithms are primarily leveraged when using time-series data to make predictions about future outcomes, such as stock market predictions or sales forecasting. The artificial neural network 2100 is implemented as any type of neural network suitable for a given operational task of system 1800, and the MLP, CNN, and RNN are merely a few examples. Embodiments are not limited in this context.

The artificial neural network 2100 includes a set of associated parameters 2134. There are a number of different parameters that must be decided upon when designing a neural network. Among these parameters are the number of layers, the number of neurons per layer, the number of training iterations, and so forth. Some of the more important parameters in terms of training and network capacity are a number of hidden neurons parameter, a learning rate parameter, a momentum parameter, a training type parameter, an Epoch parameter, a minimum error parameter, and so forth.

In some cases, the artificial neural network 2100 is implemented as a deep learning neural network. The term deep learning neural network refers to a depth of layers in a given neural network. A neural network that has more than three layers—which would be inclusive of the inputs and the output—can be considered a deep learning algorithm. A neural network that only has two or three layers, however, may be referred to as a basic neural network. A deep learning neural network may tune and optimize one or more hyperparameters 2136. A hyperparameter is a parameter whose values are set before starting the model training process. Deep learning models, including convolutional neural network (CNN) and recurrent neural network (RNN) models can have anywhere from a few hyperparameters to a few hundred hyperparameters. The values specified for these hyperparameters impacts the model learning rate and other regulations during the training process as well as final model performance. A deep learning neural network uses hyperparameter optimization algorithms to automatically optimize models. The algorithms used include Random Search, Tree-structured Parzen Estimator (TPE) and Bayesian optimization based on the Gaussian process. These algorithms are combined with a distributed training engine for quick parallel searching of the optimal hyperparameter values.

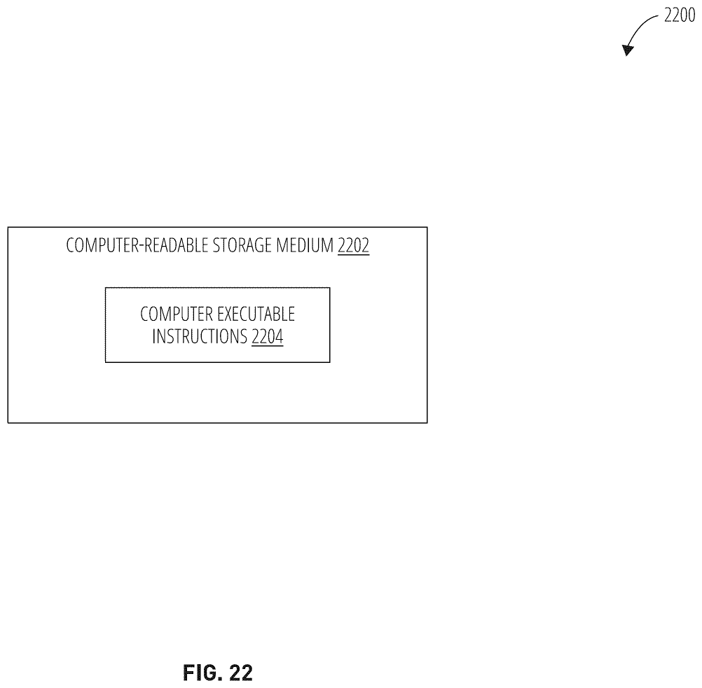

FIG. 22 illustrates an apparatus 2200. Apparatus 2200 comprises any non-transitory computer-readable storage medium 2202 or machine-readable storage medium, such as an optical, magnetic or semiconductor storage medium. In various embodiments, apparatus 2200 comprises an article of manufacture or a product. In some embodiments, the computer-readable storage medium 2202 stores computer executable instructions with which one or more processing devices or processing circuitry can execute. For example, computer executable instructions 2204 includes instructions to implement operations described with respect to any logic flows described herein. Examples of computer-readable storage medium 2202 or machine-readable storage medium include any tangible media capable of storing electronic data, including volatile memory or non-volatile memory, removable or non-removable memory, erasable or non-erasable memory, writeable or re-writeable memory, and so forth. Examples of computer executable instructions 2204 include any suitable type of code, such as source code, compiled code, interpreted code, executable code, static code, dynamic code, object-oriented code, visual code, and the like.

FIG. 23 illustrates an embodiment of a computing architecture 2300. Computing architecture 2300 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the computing architecture 2300 has a single processor with one core or more than one processor. Note that the term “processor” refers to a processor with a single core or a processor package with multiple processor cores. In at least one embodiment, the computing architecture 2300 is representative of the components of the system 1800. More generally, the computing architecture 2300 is configured to implement all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary computing architecture 2300. For example, a component is, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server are a component. One or more components reside within a process and/or thread of execution, and a component is localized on one computer and/or distributed between two or more computers. Further, components are communicatively coupled to each other by various types of communications media to coordinate operations. The coordination involves the uni-directional or bi-directional exchange of information. For instance, the components communicate information in the form of signals communicated over the communications media. The information is implemented as signals allocated to various signal lines. In such allocations, each message is a signal. Further embodiments, however, alternatively employ data messages. Such data messages may be sent across various connections. Exemplary connections include parallel interfaces, serial interfaces, and bus interfaces.

As shown in FIG. 23, computing architecture 2300 comprises a system-on-chip (SoC) 2302 for mounting platform components. System-on-chip (SoC) 2302 is a point-to-point (P2P) interconnect platform that includes a first processor 2304 and a second processor 2306 coupled via a point-to-point interconnect 2370 such as an Ultra Path Interconnect (UPI). In other embodiments, the computing architecture 2300 is another bus architecture, such as a multi-drop bus. Furthermore, each of processor 2304 and processor 2306 are processor packages with multiple processor cores including core(s) 2308 and core(s) 2310, respectively. While the computing architecture 2300 is an example of a two-socket (2S) platform, other embodiments include more than two sockets or one socket. For example, some embodiments include a four-socket (4S) platform or an eight-socket (8S) platform. Each socket is a mount for a processor and may have a socket identifier. Note that the term platform refers to a motherboard with certain components mounted such as the processor 2304 and chipset 2332. Some platforms include additional components and some platforms include sockets to mount the processors and/or the chipset. Furthermore, some platforms do not have sockets (e.g. SoC, or the like). Although depicted as a SoC 2302, one or more of the components of the SoC 2302 are included in a single die package, a multi-chip module (MCM), a multi-die package, a chiplet, a bridge, and/or an interposer. Therefore, embodiments are not limited to a SoC.

The processor 2304 and processor 2306 are any commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures are also employed as the processor 2304 and/or processor 2306. Additionally, the processor 2304 need not be identical to processor 2306.

Processor 2304 includes an integrated memory controller (IMC) 2320 and point-to-point (P2P) interface 2324 and P2P interface 2328. Similarly, the processor 2306 includes an IMC 2322 as well as P2P interface 2326 and P2P interface 2330. IMC 2320 and IMC 2322 couple the processor 2304 and processor 2306, respectively, to respective memories (e.g., memory 2316 and memory 2318). Memory 2316 and memory 2318 are portions of the main memory (e.g., a dynamic random-access memory (DRAM)) for the platform such as double data rate type 4 (DDR4) or type 5 (DDR5) synchronous DRAM (SDRAM). In the present embodiment, the memory 2316 and the memory 2318 locally attach to the respective processors (i.e., processor 2304 and processor 2306). In other embodiments, the main memory couple with the processors via a bus and shared memory hub. Processor 2304 includes registers 2312 and processor 2306 includes registers 2314.

Computing architecture 2300 includes chipset 2332 coupled to processor 2304 and processor 2306. Furthermore, chipset 2332 are coupled to storage device 2350, for example, via an interface (I/F) 2338. The I/F 2338 may be, for example, a Peripheral Component Interconnect-enhanced (PCIe) interface, a Compute Express Link® (CXL) interface, or a Universal Chiplet Interconnect Express (UCIe) interface. Storage device 2350 stores instructions executable by circuitry of computing architecture 2300 (e.g., processor 2304, processor 2306, GPU 2348, accelerator 2354, vision processing unit 2356, or the like). For example, storage device 2350 can store instructions for the client device 1802, the client device 1806, the inferencing device 1804, the training device 1914, or the like.

Processor 2304 couples to the chipset 2332 via P2P interface 2328 and P2P 2334 while processor 2306 couples to the chipset 2332 via P2P interface 2330 and P2P 2336. Direct media interface (DMI) 2376 and DMI 2378 couple the P2P interface 2328 and the P2P 2334 and the P2P interface 2330 and P2P 2336, respectively. DMI 2376 and DMI 2378 is a high-speed interconnect that facilitates, e.g., eight Giga Transfers per second (GT/s) such as DMI 3.0. In other embodiments, the processor 2304 and processor 2306 interconnect via a bus.

The chipset 2332 comprises a controller hub such as a platform controller hub (PCH). The chipset 2332 includes a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 2332 comprises more than one controller hub such as a chipset with a memory controller hub, a graphics controller hub, and an input/output (I/O) controller hub.

In the depicted example, chipset 2332 couples with a trusted platform module (TPM) 2344 and UEFI, BIOS, FLASH circuitry 2346 via I/F 2342. The TPM 2344 is a dedicated microcontroller designed to secure hardware by integrating cryptographic keys into devices. The UEFI, BIOS, FLASH circuitry 2346 may provide pre-boot code. The I/F 2342 may also be coupled to a network interface circuit (NIC) 2380 for connections off-chip.

Furthermore, chipset 2332 includes the I/F 2338 to couple chipset 2332 with a high-performance graphics engine, such as, graphics processing circuitry or a graphics processing unit (GPU) 2348. In other embodiments, the computing architecture 2300 includes a flexible display interface (FDI) (not shown) between the processor 2304 and/or the processor 2306 and the chipset 2332. The FDI interconnects a graphics processor core in one or more of processor 2304 and/or processor 2306 with the chipset 2332.

The computing architecture 2300 is operable to communicate with wired and wireless devices or entities via the network interface (NIC) 180 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE wireless technologies, among others. Thus, the communication is a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network is used to connect computers to each other, to the Internet, and to wired networks (which use IEEE 802.3-related media and functions).

Additionally, accelerator 2354 and/or vision processing unit 2356 are coupled to chipset 2332 via I/F 2338. The accelerator 2354 is representative of any type of accelerator device (e.g., a data streaming accelerator, cryptographic accelerator, cryptographic co-processor, an offload engine, etc.). One example of an accelerator 2354 is the Intel® Data Streaming Accelerator (DSA). The accelerator 2354 is a device including circuitry to accelerate copy operations, data encryption, hash value computation, data comparison operations (including comparison of data in memory 2316 and/or memory 2318), and/or data compression. Examples for the accelerator 2354 include a USB device, PCI device, PCIe device, CXL device, UCIe device, and/or an SPI device. The accelerator 2354 also includes circuitry arranged to execute machine learning (ML) related operations (e.g., training, inference, etc.) for ML models. Generally, the accelerator 2354 is specially designed to perform computationally intensive operations, such as hash value computations, comparison operations, cryptographic operations, and/or compression operations, in a manner that is more efficient than when performed by the processor 2304 or processor 2306. Because the load of the computing architecture 2300 includes hash value computations, comparison operations, cryptographic operations, and/or compression operations, the accelerator 2354 greatly increases performance of the computing architecture 2300 for these operations.

The accelerator 2354 includes one or more dedicated work queues and one or more shared work queues (each not pictured). Generally, a shared work queue is configured to store descriptors submitted by multiple software entities. The software is any type of executable code, such as a process, a thread, an application, a virtual machine, a container, a microservice, etc., that share the accelerator 2354. For example, the accelerator 2354 is shared according to the Single Root I/O virtualization (SR-IOV) architecture and/or the Scalable I/O virtualization (S-IOV) architecture. Embodiments are not limited in these contexts. In some embodiments, software uses an instruction to atomically submit the descriptor to the accelerator 2354 via a non-posted write (e.g., a deferred memory write (DMWr)). One example of an instruction that atomically submits a work descriptor to the shared work queue of the accelerator 2354 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 2354. The dedicated work queue may accept job submissions via commands such as the movdir64b instruction.

Various I/O devices 2360 and display 2352 couple to the bus 2372, along with a bus bridge 2358 which couples the bus 2372 to a second bus 2374 and an I/F 2340 that connects the bus 2372 with the chipset 2332. In one embodiment, the second bus 2374 is a low pin count (LPC) bus. Various input/output (I/O) devices couple to the second bus 2374 including, for example, a keyboard 2362, a mouse 2364 and communication devices 2366.

Furthermore, an audio I/O 2368 couples to second bus 2374. Many of the I/O devices 2360 and communication devices 2366 reside on the system-on-chip (SoC) 2302 while the keyboard 2362 and the mouse 2364 are add-on peripherals. In other embodiments, some or all the I/O devices 2360 and communication devices 2366 are add-on peripherals and do not reside on the system-on-chip (SoC) 2302.

FIG. 24 illustrates a block diagram of an exemplary communications architecture 2400 suitable for implementing various embodiments as previously described. The communications architecture 2400 includes various common communications elements, such as a transmitter, receiver, transceiver, radio, network interface, baseband processor, antenna, amplifiers, filters, power supplies, and so forth. The embodiments, however, are not limited to implementation by the communications architecture 2400.

As shown in FIG. 24, the communications architecture 2400 includes one or more clients 2402 and servers 2404. The clients 2402 and the servers 2404 are operatively connected to one or more respective client data stores 2408 and server data stores 2410 that can be employed to store information local to the respective clients 2402 and servers 2404, such as cookies and/or associated contextual information.

The clients 2402 and the servers 2404 communicate information between each other using a communication framework 2406. The communication framework 2406 implements any well-known communications techniques and protocols. The communication framework 2406 is implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 2406 implements various network interfaces arranged to accept, communicate, and connect to a communications network. A network interface is regarded as a specialized form of an input output interface. Network interfaces employ connection protocols including without limitation direct connect, Ethernet (e.g., thick, thin, twisted pair 10/1800/1000 Base T, and the like), token ring, wireless network interfaces, cellular network interfaces, IEEE 802.11 network interfaces, IEEE 802.16 network interfaces, IEEE 802.20 network interfaces, and the like. Further, multiple network interfaces are used to engage with various communications network types. For example, multiple network interfaces are employed to allow for the communication over broadcast, multicast, and unicast networks. Should processing requirements dictate a greater amount speed and capacity, distributed network controller architectures are similarly employed to pool, load balance, and otherwise increase the communicative bandwidth required by clients 2402 and the servers 2404. A communications network is any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The various elements of the devices as previously described with reference to the figures include various hardware elements, software elements, or a combination of both. Examples of hardware elements include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements varies in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment are implemented by representative instructions stored on a machine-readable medium which represents various logic within the processor, which when read by a machine causes the machine to fabricate logic to perform the techniques described herein. Such representations, known as “intellectual property (IP) cores” are stored on a tangible, machine readable medium and supplied to various customers or manufacturing facilities to load into the fabrication machines that make the logic or processor. Some embodiments are implemented, for example, using a machine-readable medium or article which may store an instruction or a set of instructions that, when executed by a machine, causes the machine to perform a method and/or operations in accordance with the embodiments. Such a machine includes, for example, any suitable processing platform, computing platform, computing device, processing device, computing system, processing system, processing devices, computer, processor, or the like, and is implemented using any suitable combination of hardware and/or software. The machine-readable medium or article includes, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions include any suitable type of code, such as source code, compiled code, interpreted code, executable code, static code, dynamic code, encrypted code, and the like, implemented using any suitable high-level, low-level, object-oriented, visual, compiled and/or interpreted programming language.

As utilized herein, terms “component,” “system,” “interface,” and the like are intended to refer to a computer-related entity, hardware, software (e.g., in execution), and/or firmware. For example, a component is a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server is also a component. One or more components reside within a process, and a component is localized on one computer and/or distributed between two or more computers. A set of elements or a set of other components are described herein, in which the term “set” can be interpreted as “one or more.”

Further, these components execute from various computer readable storage media having various data structures stored thereon such as with a module, for example. The components communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component is an apparatus with specific functionality provided by mechanical parts operated by electric or electronic circuitry, in which the electric or electronic circuitry is operated by a software application or a firmware application executed by one or more processors. The one or more processors are internal or external to the apparatus and execute at least a part of the software or firmware application. As yet another example, a component is an apparatus that provides specific functionality through electronic components without mechanical parts; the electronic components include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items may be distinct or they may be the same, although in some situations the context may indicate that they are distinct or that they are the same.

As used herein, the term “circuitry” may refer to, be part of, or include a circuit, an integrated circuit (IC), a monolithic IC, a discrete circuit, a hybrid integrated circuit (HIC), an Application Specific Integrated Circuit (ASIC), an electronic circuit, a logic circuit, a microcircuit, a hybrid circuit, a microchip, a chip, a chiplet, a chipset, a multi-chip module (MCM), a semiconductor die, a system on a chip (SoC), a processor (shared, dedicated, or group), a processor circuit, a processing circuit, or associated memory (shared, dedicated, or group) operably coupled to the circuitry that execute one or more software or firmware programs, a combinational logic circuit, or other suitable hardware components that provide the described functionality. In some embodiments, the circuitry is implemented in, or functions associated with the circuitry are implemented by, one or more software or firmware modules. In some embodiments, circuitry includes logic, at least partially operable in hardware. It is noted that hardware, firmware and/or software elements may be collectively or individually referred to herein as “logic” or “circuit.”

Some embodiments are described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately can be employed in combination with each other unless it is noted that the features are incompatible with each other.

Some embodiments are presented in terms of program procedures executed on a computer or network of computers. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments are described using the expression “coupled” and “connected” along with their derivatives. These terms are not necessarily intended as synonyms for each other. For example, some embodiments are described using the terms “connected” and/or “coupled” to indicate that two or more elements are in direct physical or electrical contact with each other. The term “coupled,” however, also means that two or more elements are not in direct contact with each other, but yet still co-operate or interact with each other.

Various embodiments also relate to apparatus or systems for performing these operations. This apparatus is specially constructed for the required purpose or it comprises a general purpose computer as selectively activated or reconfigured by a computer program stored in the computer. The procedures presented herein are not inherently related to a particular computer or other apparatus. Various general purpose machines are used with programs written in accordance with the teachings herein, or it proves convenient to construct more specialized apparatus to perform the required method steps. The required structure for a variety of these machines are apparent from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice.

According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalisation tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

What is claimed is:

1. A method, comprising:
generating an input feature vector for a set of features by using an embedding layer of a residual deep and cross network (DCN);
generating a first output feature vector representing explicit feature crosses of the input feature vector using a set of cross layers of a cross network of the residual DCN, with at least one cross layer comprising a set of attention data structures to generate attention scores for feature crosses of the set of features from the input feature vector;
generating a prediction vector for the defined prediction task based, at least in part, on the first output feature vector; and
providing a recommendation for a connections networking system based on the prediction vector.

2. The method of claim 1, wherein the set of features comprises one or more numerical features, categorical features, categorical feature embeddings from a lookup table, dense embeddings, sparse identifier embeddings, or member history features defined for the connections networking system.

3. The method of claim 1, wherein the at least one cross layer comprises a set of low-rank matrices representing low-rank approximations of a full-rank weight matrix, the set of low-rank matrices comprising a first low-rank matrix representing a first subspace of the full-rank weight matrix and a second low-rank matrix representing a second subspace of the full-rank weight matrix.

4. The method of claim 1, wherein the set of attention data structures comprise an attention score matrix and a value matrix, the attention score matrix comprising a combination of a query matrix and a key matrix.

5. The method of claim 1, comprising:
generating a cross layer input feature vector based on the input feature vector;
multiplying the cross layer input feature vector with a first low-rank matrix of a set of low-rank matrices to form a query matrix;
multiplying the cross layer input feature vector with the first low-rank matrix of the set of low-rank matrices to form a key matrix; and
multiplying the query matrix and the key matrix to form an attention score matrix for the at least one cross layer.

6. The method of claim 1, comprising generating a cross layer output feature vector by the at least one cross layer using a set of operations comprising:
multiplying a first cross layer input feature vector with a first low-rank matrix of a set of low-rank matrices and an attention score matrix to form a first intermediate result;
multiplying the first intermediate result with a second low-rank matrix of the set of low-rank matrices to form a second intermediate result;
adding a bias vector to the second intermediate result to form a third intermediate result;
multiplying the third intermediate result with the input feature vector to form a fourth intermediate result; and
adding the first cross layer input feature vector to the fourth intermediate result via a residual connection to form the cross layer output feature vector, the residual connection comprising a skip connection.

7. The method of claim 1, comprising:
generating a first cross layer output feature vector by a first cross layer based on the input feature vector and a first cross layer input feature vector;
generating a second cross layer output feature vector by a second cross layer based on the input feature vector and the first cross layer output feature vector; and
providing the second cross layer output feature vector to an output layer of the cross network.

8. The method of claim 1, comprising:
generating a second output feature vector representing implicit feature crosses of the input feature vector using a deep neural network (DNN) of the residual DCN;
combining the first output feature vector and the second output feature vector into a final output feature vector by a final layer of the residual DCN; and
generating the prediction vector based on the final output feature vector.

9. The method of claim 8, comprising calibrating a set of predicted values from the prediction vector using a calibration model co-trained with the residual DCN using operations comprising:
mapping the set of predicted values to a corresponding set of intervals associated with a set of calibrated scores using an isotonic calibration layer of a calibration model, the isotonic calibration layer using an isotonic regression function that is monotonically increasing or decreasing to preserve an order of the set of prediction values; and
replacing the set of prediction values with the set of calibrated scores based on the mapping.

10. The method of claim 1, comprising:
accessing a training dataset comprising a set of datapoints to train the set of cross layers of the cross network for the residual DCN, the set of datapoints comprising input feature vectors and output feature vectors, the input feature vectors representing a set of features for a connections networking system and the output feature vectors representing a set of feature crosses for the set of features;
generating a candidate output feature vector for an input feature vector of a datapoint by the set of cross layers of the cross network;
determining a difference value between the candidate output feature vector and an output feature vector associated with the input feature vector of the datapoint; and
updating the attention parameters for the attention data structures of the at least one cross layer based on the difference value and a loss function.

11. A computing apparatus, comprising:
processing circuitry; and
a memory storing instructions that, when executed by the processing circuitry, cause the processing circuitry to:
generate an input feature vector for a set of features by using an embedding layer of a residual deep and cross network (DCN);
generate a first output feature vector representing explicit feature crosses of the input feature vector using a set of cross layers of a cross network of the residual DCN, with at least one cross layer comprising a set of attention data structures to generate attention scores for feature crosses of the set of features from the input feature vector;
generate a prediction vector for the defined prediction task based, at least in part, on the first output feature vector; and
provide a recommendation for a networking service of a connections networking system based on the prediction vector.

12. The computing apparatus of claim 11, comprising:
generate a cross layer input feature vector based on the input feature vector;
multiply the cross layer input feature vector with a first low-rank matrix of a set of low-rank matrices to form a query matrix;
multiply the cross layer input feature vector with the first low-rank matrix of the set of low-rank matrices to form a key matrix; and
multiply the query matrix and the key matrix to form an attention score matrix for the at least one cross layer.

13. The computing apparatus of claim 11, comprising generate a cross layer output feature vector by the at least one cross layer using a set of operations comprising:
multiply a first cross layer input feature vector with a first low-rank matrix of a set of low-rank matrices and an attention score matrix to form a first intermediate result;
multiply the first intermediate result with a second low-rank matrix of the set of low-rank matrices to form a second intermediate result;
add a bias vector to the second intermediate result to form a third intermediate result;
multiply the third intermediate result with the input feature vector to form a fourth intermediate result; and
add the first cross layer input feature vector to the fourth intermediate result via a residual connection to form the cross layer output feature vector, the residual connection comprising a skip connection.

14. The computing apparatus of claim 11, comprising:
generate a second output feature vector representing implicit feature crosses of the input feature vector using a deep neural network (DNN) of the residual DCN;
combine the first output feature vector and the second output feature vector into a final output feature vector by a final layer of the residual DCN; and
generate the prediction vector based on the final output feature vector.

15. The computing apparatus of claim 14, comprising calibrate a set of predicted values from the prediction vector using a calibration model co-trained with the residual DCN using operations comprising:
map the set of predicted values to a corresponding set of intervals associated with a set of calibrated scores using an isotonic calibration layer of a calibration model, the isotonic calibration layer using an isotonic regression function that is monotonically increasing or decreasing to preserve an order of the set of prediction values; and
replace the set of prediction values with the set of calibrated scores based on the mapping.

16. A non-transitory computer-readable storage medium, the computer-readable storage medium including instructions that when executed by processing circuitry, cause the processing circuitry to:
generate an input feature vector for a set of features by using an embedding layer of a residual deep and cross network (DCN);
generate a first output feature vector representing explicit feature crosses of the input feature vector using a set of cross layers of a cross network of the residual DCN, with at least one cross layer comprising a set of attention data structures to generate attention scores for feature crosses of the set of features from the input feature vector;
generate a prediction vector for the defined prediction task based, at least in part, on the first output feature vector; and
provide a recommendation for a networking service of a connections networking system based on the prediction vector.

17. The computer-readable storage medium of claim 16, comprising:
generate a cross layer input feature vector based on the input feature vector;
multiply the cross layer input feature vector with a first low-rank matrix of a set of low-rank matrices to form a query matrix;
multiply the cross layer input feature vector with the first low-rank matrix of the set of low-rank matrices to form a key matrix; and
multiply the query matrix and the key matrix to form an attention score matrix for the at least one cross layer.

18. The computer-readable storage medium of claim 16, comprising generate a cross layer output feature vector by the at least one cross layer using a set of operations comprising:
multiply a first cross layer input feature vector with a first low-rank matrix of a set of low-rank matrices and an attention score matrix to form a first intermediate result;
multiply the first intermediate result with a second low-rank matrix of the set of low-rank matrices to form a second intermediate result;
add a bias vector to the second intermediate result to form a third intermediate result;
multiply the third intermediate result with the input feature vector to form a fourth intermediate result; and
add the first cross layer input feature vector to the fourth intermediate result via a residual connection to form the cross layer output feature vector, the residual connection comprising a skip connection.

19. The computer-readable storage medium of claim 16, comprising:
generate a second output feature vector representing implicit feature crosses of the input feature vector using a deep neural network (DNN) of the residual DCN;
combine the first output feature vector and the second output feature vector into a final output feature vector by a final layer of the residual DCN; and
generate the prediction vector based on the final output feature vector.

20. The computer-readable storage medium of claim 19, comprising calibrate a set of predicted values from the prediction vector using a calibration model co-trained with the residual DCN using operations comprising:
map the set of predicted values to a corresponding set of intervals associated with a set of calibrated scores using an isotonic calibration layer of a calibration model, the isotonic calibration layer using an isotonic regression function that is monotonically increasing or decreasing to preserve an order of the set of prediction values; and
replace the set of prediction values with the set of calibrated scores based on the mapping.
